(19) United States
(12) Patent Application Publication
(10) Pub. No.: US 2026/0304366 A1
(43) Pub. Date: Oct. 1, 2026

(54) TIME-AVERAGED RADIO FREQUENCY EXPOSURE EVALUATION WITH TISSUE REGISTRATION

(71) Applicant: QUALCOMM Incorporated, San Diego, CA (US)

(72) Inventors: Lin LU, San Diego, CA (US); Jagadish NADAKUDUTI, San Diego, CA (US); Nandhini SRINIVASAN, San Diego, CA (US); Paul GUCKIAN, La Jolla, CA (US)

(21) Appl. No.: 19/577,830

(22) Filed: Mar. 25, 2026

Related U.S. Application Data
(60) Provisional application No. 63/778,165, filed on Mar. 26, 2025.

(51) Int. Cl. H04W 64/00

(52) U.S. Cl. CPC H04W 64/00

(57) ABSTRACT

Techniques and apparatus for radio frequency (RF) exposure evaluation with tissue registration are described. An example method that may be performed by a wireless device includes tracking presence of one or more tissues associated with a human body corresponding to a plurality of locations across the wireless device over time. RF exposure associated with the plurality of locations is tracked over time. A signal is transmitted at a transmit power determined based at least in part on the tracked RF exposure and the tracked presence of the one or more tissues in compliance with an RF exposure limit.

### CROSS-REFERENCE TO RELATED APPLICATION

This application claims the benefit of and priority to U.S. Provisional Patent Application Ser. No. 63/778,165, filed Mar. 26, 2025, which is assigned to the assignee hereof and hereby expressly incorporated by reference herein.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modem wireless communication devices (such as cellular telephones) are generally mandated to meet radio frequency (RF) exposure limits set by certain governments and international standards and regulations. To ensure compliance with the standards, such devices currently undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide advantages that include improved wireless communication performance while complying with radio frequency (RF) exposure limits.

Certain aspects of the subject matter described in this disclosure can be implemented in a method for wireless communication. The method generally includes tracking presence of one or more tissues associated with a human body corresponding to a plurality of locations across the wireless device over time. The method also includes tracking RF exposure associated with the plurality of locations over time. The method further includes transmitting a signal at a transmit power determined based at least in part on the tracked RF exposure and the tracked presence of the one or more tissues in compliance with an RF exposure limit.

Certain aspects of the subject matter described in this disclosure can be implemented in an apparatus for wireless communication. The apparatus generally includes one or more memories collectively storing executable instructions, and one or more processors coupled to the one or more memories. The one or more processors are collectively configured to execute the executable instructions to cause the apparatus to: track presence of one or more tissues associated with a human body corresponding to a plurality of locations across the apparatus over time; track RF exposure associated with the plurality of locations over time; and transmit a signal at a transmit power determined based at least in part on the tracked RF exposure and the tracked presence of the one or more tissues in compliance with an RF exposure limit.

Certain aspects of the subject matter described in this disclosure can be implemented in an apparatus for wireless communication. The apparatus generally includes means for tracking presence of one or more tissues associated with a human body corresponding to a plurality of locations across the apparatus over time. The apparatus also includes means for tracking RF exposure associated with the plurality of locations over time. The apparatus further includes means for transmitting a signal at a transmit power determined based at least in part on the tracked RF exposure and the tracked presence of the one or more tissues in compliance with an RF exposure limit.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human, in accordance with certain aspects of the present disclosure.

FIG. 2 is a block diagram conceptually illustrating a design of an example wireless communication device communicating with another device, in accordance with certain aspects of the present disclosure.

FIG. 3 is a graph illustrating examples of transmit powers over time in compliance with an RF exposure limit, in accordance with certain aspects of the present disclosure.

FIG. 4A is a diagram illustrating an example wireless device having multiple radios, in accordance with certain aspects of the present disclosure.

FIG. 4B is a diagram illustrating an example logical architecture for controlling the transmit power associated with one or more radios of a wireless device, in accordance with certain aspects of the present disclosure.

FIG. 5 is a block diagram illustrating an example grouping of multiple antennas of a wireless device, in accordance with certain aspects of the present disclosure.

FIGS. 6A-6C depict various examples of time-averaged RF exposure evaluation, in accordance with certain aspects of the present disclosure.

FIG. 7 depicts an example of time-averaged RF exposure evaluation that may be used with tissue presence or registration, in accordance with certain aspects of the present disclosure.

FIG. 8 depicts an example of RF exposure contours for a wireless device, in accordance with certain aspects of the present disclosure.

FIG. 9 depicts a time-averaged RF exposure evaluation performed without tissue registration and a time-averaged RF exposure evaluation performed with tissue registration, in accordance with certain aspects of the present disclosure.

FIG. 10 depicts a time-averaged RF exposure evaluation performed with tissue registration with tissue movement over time, in accordance with certain aspects of the present disclosure.

FIG. 11 depicts a time-averaged RF exposure evaluation performed without tissue registration and a time-averaged RF exposure evaluation performed with tissue registration for particular types of tissues, in accordance with certain aspects of the present disclosure.

FIG. 12 depicts a time-averaged RF exposure evaluation performed with tissue registration with tissue movement of particular types of tissues over time, in accordance with certain aspects of the present disclosure.

FIG. 13 is a flowchart of example operations for wireless communication, in accordance with certain aspects of the present disclosure.

FIG. 14 illustrates a communications device (e.g., a user equipment (UE)) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for complying with radio frequency (RF) exposure limits. RF exposure across different locations (or regions) on a wireless device may be determined and/or tracked for different tissues and/or locations on a body of a user.

In certain cases, a regulatory agency (e.g., the Federal Communications Commission (FCC) for the United States or the Innovation, Science and Economic Development Canada (ISED) for Canada) and/or a standards organization (e.g., the International Commission on Non-Ionizing Radiation Protection (ICNIRP)) may specify a time-averaged RF exposure limit in order to ensure safe levels of RF exposure as further described herein. In such cases, a wireless device may evaluate RF exposure compliance using a time-averaged operation. For example, the wireless device may perform an RF exposure assessment of past RF exposure over a given time window (e.g., time-averaging window) to determine a transmit power (e.g., maximum allowable transmit power) for a future time interval in the time window that is in compliance with the RF exposure limit (e.g., time-averaged RF exposure limit) for a given transmit scenario associated with the wireless device. As used herein, a transmit scenario may correspond to various combinations of radios, communication technologies (e.g., radio access technologies (RATs)), antennas, antenna groupings, antenna configurations (or beams) (e.g., transmit beam configuration), single-input, single-output (SISO) or multiple-input, multiple-output (MIMO) transmissions, operating conditions, frequency bands, RF exposure scenarios (e.g., head exposure, body-worn exposure, extremity (hand) exposure, and/or hotspot exposure), device use-case scenarios (e.g., based on active applications on the device, such as voice vs. data applications, gaming vs. video-call applications active on the device), physical configurations of a device (e.g., folded, closed, unfolded, open), and/or geographical locations or regions (e.g., countries or regions), as illustrative, non-limiting examples.

In certain cases, a wireless device may evaluate a time-averaged RF exposure over a time window (e.g., time-averaging window) using RF exposure contribution information associated with antennas/radios of the wireless device. The RF exposure contribution information may include, for each antenna, an indication of spatial contribution of RF exposure from the antenna on one or more RF exposure contributors. In some cases, the RF exposure contributor(s) may include each other antenna of the wireless device. In other cases, the RF exposure contributor(s) may include one or more composite RF exposure maps for one or more antennas of the wireless device. In other cases, the RF exposure contributor(s) may include one or more regions of an RF exposure distribution (or map) for the wireless device. In yet other cases, the RF exposure contributor(s) may include one or more surfaces of the wireless device.

However, one potential issue with evaluating time-averaged RF exposure based on such RF exposure contribution information is that the RF exposure contribution information generally assumes that human tissue (e.g., tissue associated with a user) is present at all times across all locations of the wireless device during the time window (e.g., time-averaging window). In certain scenarios, however, a given location on the wireless device may expose RF energy to human tissue for the entire duration of the time window, may expose RF energy to human tissue for a portion of the duration of the time window, may expose RF energy to the same tissue during (all or a portion of) the time window, may expose RF energy to different tissues during (all or a portion of) the time window, or may not expose RF energy to human tissue at all during the time window.

By way of example, in certain cases, a wireless device may evaluate a time-averaged RF exposure over a time window (e.g., time-averaging window) where the wireless device encountered different exposure scenarios during the time window. For example, during a first portion of the time window, the wireless device may be in a head exposure scenario (e.g., exp1), and during a second portion of the time window, the wireless device may be in a body-worn exposure scenario (e.g., exp2). In these cases, the different exposures may be correlated over the time window of the time-averaged RF exposure limit, such that the different exposures are evaluated in the same time-averaged function for determining the available transmit power margin (e.g., ƒ(exp1, exp2, t)). Such a technique for determining the available transmit power margin may provide reduced wireless communication performance (e.g., higher latency, lower data rates, decreased range of communications, etc.), for example, due to the application of the same RF exposure settings for the time-averaged function despite there being different RF exposure scenarios.

Certain aspects of the present disclosure provide techniques and apparatus for performing time-averaging RF exposure evaluation for a wireless device, based at least in part on sensor information indicating whether tissue is present for one or more locations across the wireless device. The wireless device may track, using the sensor information, presence of one or more tissues associated with a human body corresponding to one or more locations across the wireless device over time. Based on the sensor information, the wireless device may evaluate the time-averaged RF exposure for each location on the wireless device where tissue is detected, as further described herein. In certain aspects, the sensor information may also indicate whether a particular type of tissue (e.g., tissue identifier (ID)) is present for one or more locations across the wireless device. In such aspects, the wireless device may evaluate, for each location on the wireless device where tissue is detected, the time-averaged RF exposure for the type of tissue that is detected for the location, as further described herein.

The apparatus and techniques for implementing RF exposure compliance based on sensor information indicating presence of tissue corresponding to various locations on the wireless device, as described herein, may enable desirable transmit power for specific radios, antennas, and/or antenna groups (AGs), for example, due to differing exposure encountered by each. The desirable transmit power may provide desirable wireless communication performance, such as increased data rates, reduced latency, and/or increased transmission range, as illustrative examples.

In certain aspects, the wireless device may use a trained machine learning model (e.g., a neural network) to perform one or more operations associated with RF exposure compliance. For example, the trained machine learning model may be used to determine one or more of: the transmit power based on the tracked RF exposure and tracked tissue presence, RF exposure contribution information, tissue type identification from sensor information, and/or time-averaged RF exposure evaluation. In some cases, the machine learning model may be trained using training data comprising historical RF exposure data, sensor information, and/or corresponding transmit power levels that comply with RF exposure limits, as illustrative examples. The trained machine learning model may enable the wireless device to more accurately and efficiently determine transmit power levels that comply with RF exposure limits while providing desirable wireless communication performance (e.g., increased data rates, reduced latency, and/or increased transmission range).

As used herein, a radio may refer to a physical or logical transmission path associated with one or more active frequency bands, transceivers, and/or RATs (e.g., radio frequency identification (RFID), code division multiple access (CDMA), Long Term Evolution (LTE), new radio (NR), Institute of Electrical and Electronics Engineers (IEEE) 802.11, Bluetooth, etc.) used for wireless communications. For example, for uplink carrier aggregation in LTE and/or NR, each of the active component carriers used for wireless communications may be treated as a separate radio. Similarly, multi-band transmissions for IEEE 802.11 communications may be treated as separate radios for each band (e.g., 2.4 gigahertz (GHz), 5 GHz, or 6 GHz). As used herein, a “minimum reserve” or merely “reserve” may refer to a minimum level of transmit power allocated to one or more radios for a certain duration (e.g., a transmission occasion, a time window associated with a (time-averaged) RF exposure limit, or a portion thereof).

The following description provides examples of RF exposure compliance, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced, using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a subcarrier, a frequency channel, a channel, a tone, a subband, etc. Each frequency may support a single RAT in a given geographic area in order to avoid interference between wireless networks of different RATs, or may support multiple RATs.

The techniques described herein may be used for various wireless networks and radio technologies. While aspects may be described herein using terminology commonly associated with 3G, 4G, and/or 5G (e.g., 5G NR) wireless technologies, aspects of the present disclosure can be applied in other generation-based communication systems and/or to wireless technologies such as IEEE 802.11, 802.15, etc.

Although the terms “first,” “second,” “third,” etc., may be used herein to describe various devices, elements, components, regions, layers and/or sections, these devices, elements, components, regions, layers and/or sections should not be limited by these terms. These terms may be only used to distinguish one device, element, component, region, layer or section from another device, element, component, region, layer, or section. Terms such as “first,” “second,” and other numerical terms, when used herein, do not imply a sequence or order unless clearly indicated by the context. Thus, a first device, element, component, region, layer, or section discussed herein could be termed a second device, element, component, region, layer, or section without departing from the scope of the present disclosure.

### Example Wireless Communication Network and Devices

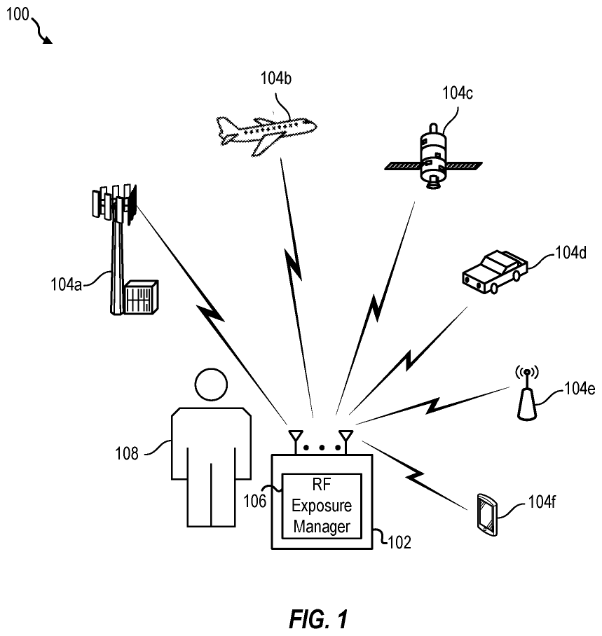

FIG. 1 illustrates an example wireless communication system 100 in which aspects of the present disclosure may be performed. For example, the wireless communication system 100 may include a radio frequency identification (RFID) system, a wireless wide area network (WWAN), a wireless local area network (WLAN), a device-to-device (D2D) communications network, a vehicle-to-everything (V2X) system, a short-range communications system (e.g., Bluetooth communications), or any combination thereof.

As illustrated in FIG. 1, the wireless communication system 100 may include a wireless device 102 communicating with any of various wireless devices 104a-104f (a wireless device 104) via any of various RATs, where a wireless device may refer to a wireless communication device. The RATs may include, for example, RFID communications, WWAN communications (e.g., Evolved Universal Mobile Telecommunications System (UMTS) Terrestrial Radio Access (E-UTRA) and/or 5G NR), WLAN communications (e.g., IEEE 802.11), V2X communications, non-terrestrial network (NTN) communications, short-range communications (e.g., Bluetooth), etc.

The wireless device 102 may be emitting RF signals in proximity to a human 108, who may be the user of the wireless device 102 and/or a bystander. As an example, the wireless device 102 may be held in the hand of the human 108 and/or positioned against or near the head of the human 108. In certain cases, the wireless device 102 may be positioned in a pocket or bag of the human 108. In some cases, the wireless device 102 may be positioned proximate to the human 108 as a mobile hotspot. To ensure the human 108 is not overexposed to RF emissions from the wireless device 102, the wireless device 102 may control the transmit power and/or transmit duration associated with the RF signals in accordance with an RF exposure limit, as further described herein, where the RF exposure limit may depend on the corresponding exposure scenario (e.g., head exposure, hand (extremity) exposure, body (body-worn) exposure, hotspot exposure, etc.).

The wireless device 102 may include any of various wireless communication devices including a user equipment (UE), a wireless station, an access point, a customer-premises equipment (CPE), etc. In certain aspects, the wireless device 102 includes an RF exposure manager 106 that manages the RF exposure associated with one or more radios in compliance with an RF exposure limit, in accordance with aspects of the present disclosure. For example, the RF exposure manager 106 may evaluate time-averaged RF exposure compliance based at least in part on sensor information indicating presence of human tissue corresponding to one or more locations across the wireless device 102, as described further herein.

The wireless devices 104a-104f may include, for example, a base station 104a, an aircraft 104b, a satellite 104c, a vehicle 104d, an access point 104e, and/or a UE 104f. Further, the wireless communication system 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always-on (AON) devices, edge processing devices, or other similar devices. A UE may also be referred to more generally as a mobile device, a wireless device, a wireless communications device, a station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. Frequency bands of 24 GHz to 71 GHz are sometimes referred to as a “millimeter wave” (“mmW” or “mmWave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as RFID, 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.1 lad, 802.11ay, 5G in mmWave bands, etc. Thus, different metrics may be used to assess RF exposure for different wireless communication technologies.

A wireless device (e.g., the wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHz (e.g., RFID, 3G, 4G, 5G, 802.11 a/b/g/n/ac, etc.) and a second wireless communication technology operating above 6 GHz (e.g., mmWave 5G in 24 to 60 GHz bands, IEEE 802.11ad or 802.11ay). In certain aspects, the wireless device may transmit signals using the first wireless communication technology (e.g., RFID, 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD. As used herein, sub-6 GHz bands may include frequency bands of 300 megahertz (MHz) to 6,000 MHz in some examples, and may include bands in the 6,000 MHz and/or 7,000 MHz range in some examples.

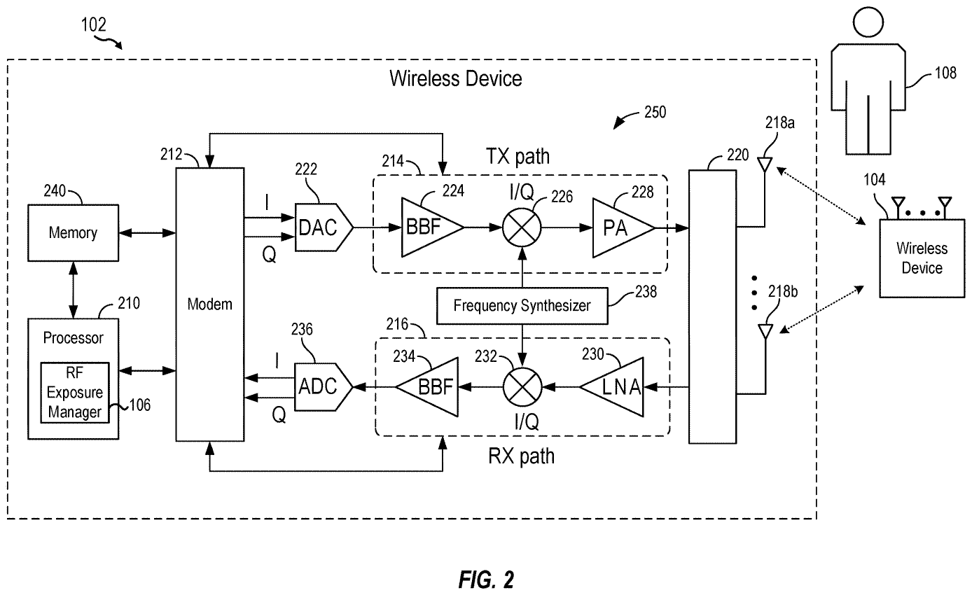

FIG. 2 illustrates example components of the wireless device 102, which may be used to communicate with any of the wireless devices 104, in some cases, in proximity to human tissue as represented by the human 108.

The wireless device 102 may be, or may include, a chip, system on chip (SoC), chipset, package or device that includes one or more modems 212. In some cases, the modem(s) 212 may include, for example, any of an RFID modem (e.g., a modem configured to communicate via RFID), a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the wireless device 102 also includes one or more radios (collectively “the radio(s) 250”). In some aspects, the wireless device 102 further includes one or more processors, processing blocks, or processing elements (collectively “the processor 210”) and one or more memory blocks or elements (collectively “the memory 240”).

The processor 210 may implement the RF exposure manager 106. In certain aspects, the processor 210 may include a processor that is representative of an application processor that generates information (e.g., application data such as content requests) for transmission and/or receives information (e.g., requested content) via the modem 212. In some cases, the processor 210 may include a microprocessor associated with the modem 212, which may process any of certain protocol stack layers associated with a RAT. For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem, the RFID modem, and/or the Bluetooth modem). For example, the processor 210 may be representative of at least one of the modems 212 in communication with one or more of the other modems 212.

The modem 212 may include an intelligent hardware block or device such as an application-specific integrated circuit (ASIC), among other possibilities. The modem 212 may generally be configured to implement a physical (PHY) layer. For example, the modem 212 may be configured to modulate packets and to output the modulated packets to the radio(s) 250 for transmission over a wireless medium. The modem 212 is similarly configured to obtain modulated packets received by the radio(s) 250 and to demodulate the packets to provide demodulated packets. In addition to a modulator and a demodulator, the modem 212 may further include digital signal processing (DSP) circuitry, automatic gain control (AGC), a coder, a decoder, a multiplexer, and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio(s) 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to a DAC 222.

Receiving I or Q baseband analog signals from the DAC 222, the TX path 214 may include a baseband filter (BBF) 224, a mixer 226, and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 226 are typically RF signals, which may be amplified by the PA 228 before transmission by the antenna(s) 218. The antenna(s) 218 may emit RF signals, which may be received at the wireless device 104. While one mixer 226 is illustrated, several mixers may be used to upconvert the filtered baseband signals to one or more intermediate frequencies and to thereafter upconvert the intermediate frequency signals to a frequency for transmission.

In some cases, the wireless device 102 may communicate via multiple-input, multiple-output (MIMO) signals. The wireless device 102 may transmit more than one signal via multiple antennas 218a, 218b (collectively “the antennas 218”) to the wireless device 104 through multipath propagation. As an example, a first signal may be transmitted via the first antenna 218a, and a second signal may be transmitted via the second antenna 218b via a different propagation path than the first signal. The MIMO signals may facilitate increased communication link capacity (e.g., throughput) between the wireless device 102 and the wireless device 104.

The RX path 216 may include a low noise amplifier (LNA) 230, a mixer 232, and a baseband filter (BBF) 234. RF signals received via the antenna 218 (e.g., from the wireless device 104) may be amplified by the LNA 230, and the mixer 232 (which may comprise one or several mixers) mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals (e.g., demodulating the digital signals).

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. The memory 240 may store data and program codes (e.g., computer-readable instructions) for performing wireless communications as described herein. The memory 240 may be external to the processor 210 and/or the modem 212 (as illustrated) and/or incorporated therein.

In certain cases, the RF exposure manager 106 (as implemented via the processor 210 and/or modem 212) may evaluate time-averaged RF exposure based at least in part on sensor information indicating presence of human tissue corresponding to one or more locations across the wireless device 102, as described further herein. For example, the RF exposure manager 106 may determine a transmit power (e.g., corresponding to certain levels of gain(s) applied to a TX path(s) 214 including the BBF 224, the mixer 226, and/or the PA 228) that applies during a time window, based in part on the time-averaged RF exposure evaluation.

FIG. 2 shows one reference example of a transceiver design. It will be appreciated that other transceiver designs or architectures may be applied in connection with certain aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

### Example RF Exposures

As noted, RF exposure may be expressed in terms of SAR and/or PD. As also noted, a wireless device (e.g., the wireless device 102) may be capable of transmitting signals using multiple wireless communication technologies. For example, the wireless device may transmit signals using a first wireless communication technology (e.g., 3G, 4G, 5G in sub-6 GHz bands, IEEE 802.11ac, etc.) in which RF exposure may be measured in terms of SAR, and a second wireless communication technology (e.g., 5G in 24 to 71 GHz bands, IEEE 802.11ad, 802.11ay, etc.) in which RF exposure may be measured in terms of PD.

To assess RF exposure from transmissions using the first technology (e.g., 3G, 4G, 5G in sub-6 GHz bands, IEEE 802.11ac, etc.), the wireless device may include multiple SAR values and/or distributions for the first technology stored in memory (e.g., memory 240 of FIG. 2). Each of the SAR values and/or distributions may correspond to a respective one of multiple transmit scenarios supported by the wireless device for the first technology. The transmit scenarios may correspond to various combinations of radios (e.g., radio(s) 250 of FIG. 2), communication technologies (e.g., RAT(s)), antennas (e.g., antenna(s) 218 of FIG. 2), antenna groupings (or antenna groups), antenna configurations, SISO or MIMO transmissions, operating conditions (or modes), frequency bands, RF exposure scenarios (e.g., head exposure, body-worn exposure, extremity (hand) exposure, and/or hotspot exposure), device use-case scenarios (e.g., based on active applications on the device such as voice vs. data applications, gaming vs. video-call applications active on the device), physical configurations of a device (e.g., folded, closed, unfolded, open), and/or geographical locations or regions (e.g., countries or regions), as discussed further below. In some examples, the stored SAR value and/or distribution includes a single value (e.g., a peak value determined based on the description below, or a sum of peak values).

The SAR values and/or distribution (also referred to as a SAR map) for each transmit scenario may be generated based on measurements (e.g., E-field measurements) performed in a test laboratory using a model of a human body. After generation, the SAR values and/or distributions are stored in the memory to enable a processor (e.g., processor 210 of FIG. 2) to assess RF exposure in real time, as discussed further below. In certain aspects, each SAR distribution may include a set of SAR values, where each SAR value may correspond to a different location of the wireless device exposing RF energy to the model of the human body, for example. Each SAR value may comprise a SAR value averaged over a mass of 1 g or 10 g at the respective location.

The SAR values in each SAR distribution correspond to a particular transmission power level (e.g., the transmission power level at which the SAR values were measured in the test laboratory). Since SAR scales with transmission power level, the processor may scale a SAR value or distribution for any transmission power level by multiplying each SAR value (e.g., in the SAR distribution) by the following transmission power scaler:

$$\frac{{Tx}_{c}}{{Tx}_{SAR}} \qquad ( 1 )$$

where Tx_{c} is a current transmission power level for the respective transmit scenario, and Tx_{SAR} is the transmission power level corresponding to the SAR values (e.g., the transmission power level at which the SAR values were measured in the test laboratory).

As discussed above, the wireless communication device may support multiple transmit scenarios for the first technology. In certain aspects, the transmit scenarios may be specified by a set of parameters. The set of parameters may include, without limitation, one or more of the following: a radio parameter indicating one or more radios used for transmission (e.g., active radios), an antenna parameter indicating one or more antennas used for transmission (e.g., active antennas), a parameter indicating SISO transmission or MIMO transmission, a parameter(s) indicating a set of operating conditions, a frequency band parameter indicating one or more frequency bands used for transmission (e.g., active frequency bands), a channel parameter indicating one or more channels used for transmission (e.g., active channels), a body position parameter (e.g., a device state index (DSI)) indicating the location of the wireless communication device relative to the user's body location (head, trunk, away from the body, etc.), exposure category, a parameter indicating at least one physical configuration of the wireless communication device, a parameter indicating a geographical location or region (e.g., public land mobile network (PLMN) code and/or a mobile country code (MCC)), and/or other parameters. In cases where the wireless device supports a large number of transmit scenarios, it may be very time-consuming and expensive to perform measurements for each transmit scenario in a test setting (e.g., test laboratory). To reduce test time, measurements may be performed for a subset of the transmit scenarios to generate SAR values and/or distributions for the subset of transmit scenarios. In this example, the SAR values and/or distributions for each of the remaining transmit scenarios may be generated by combining two or more of the SAR values and/or distributions for the subset of transmit scenarios, as discussed further below.

For example, SAR measurements may be performed for each one of the antennas to generate a SAR value or distribution for each one of the antennas. In this example, a SAR value or distribution for a transmit scenario in which two or more of the antennas are active may be generated by combining the SAR values or distributions for the two or more active antennas.

In another example, SAR measurements may be performed for each one of multiple frequency bands to generate a SAR value or distribution for each one of the multiple frequency bands. In this example, a SAR value or distribution for a transmit scenario in which two or more frequency bands are active may be generated by combining the SAR values or distributions for the two or more active frequency bands.

In certain aspects, a SAR distribution may be normalized with respect to a SAR limit by dividing each SAR value in the SAR distribution by the SAR limit. In this case, a normalized SAR value exceeds the SAR limit when the normalized SAR value is greater than one, and is below the SAR limit when the normalized SAR value is less than one. In these aspects, each of the SAR distributions stored in the memory may be normalized with respect to a SAR limit. Similarly, a single or individual SAR value may be normalized with respect to a SAR limit.

In certain aspects, the normalized SAR value or distribution for a transmit scenario may be generated by combining two or more normalized values or SAR distributions. For example, a normalized SAR value or distribution for a transmit scenario in which two or more antennas are active may be generated by combining the normalized SAR values or distributions for the two or more active antennas. For the case in which different transmission power levels are used for the active antennas, the normalized SAR value or distribution for each active antenna may be scaled by the respective transmission power level before combining the normalized SAR values or distributions for the active antennas. The normalized SAR value or distribution for simultaneous transmission from multiple active antennas may be given by the following:

$${SAR}_{norm \_ combined} = {\sum }_{i = 1}^{i = K} \frac{{Tx}_{i}}{{Tx}_{SARi}} \cdot \frac{{SAR}_{i}}{{SAR}_{lim}} \qquad ( 2 )$$

where SARₗᵢₘ is a SAR limit, SAR_{norm_combined} is the combined normalized SAR value or distribution for simultaneous transmission from the active antennas, i is an index for the active antennas, SARᵢ is the SAR value or distribution for the i^{th} active antenna, Txᵢ is the transmission power level for the i^{th} active antenna, Tx_{SARi} is the transmission power level for the SAR distribution for the i^{th} active antenna, and K is the number of the active antennas.

Equation (2) may be rewritten as follows:

$${SAR}_{norm \_ combined} = {\sum }_{i = 1}^{i = K} \frac{{Tx}_{i}}{{Tx}_{SARi}} \cdot {SAR}_{norm \_ i} \qquad ( 3 a )$$

where SAR_{norm_i} is the normalized SAR value or distribution for the i^{th} active antenna. In the case of simultaneous transmissions using multiple active antennas at the same transmitting frequency (e.g., MIMO), the combined normalized SAR value or distribution may be obtained by summing the square root of the individual normalized SAR values or distributions and computing the square of the sum, as given by the following:

$${SAR}_{norm \_ combined \_ MIMO} = {[ {\sum }_{i = 1}^{i = K} \sqrt{\frac{{Tx}_{i}}{{Tx}_{SARi}} \cdot {SAR}_{norm \_ i}} ]}^{2} . \qquad ( 3 b )$$

In another example, normalized SAR values or distributions for different frequency bands may be stored in the memory. In this example, a normalized SAR distribution for a transmit scenario in which two or more frequency bands are active may be generated by combining the normalized SAR distributions for the two or more active frequency bands. For the case where the transmission power levels are different for the active frequency bands, the normalized SAR value or distribution for each of the active frequency bands may be scaled by the respective transmission power level before combining the normalized SAR values or distributions for the active frequency bands. In this example, the combined SAR value or distribution may also be computed using Equation (3a) in which i is an index for the active frequency bands, SAR_{norm_i} is the normalized SAR value or distribution for the i^{th} active frequency band, Txᵢ is the transmission power level for the i^{th} active frequency band, and TX_{SARi} is the transmission power level for the normalized SAR value or distribution for the i^{th} active frequency band.

To assess RF exposure from transmissions using the second technology (e.g., 5G in 24 to 60 GHz bands, IEEE 802.11ad, 802.11ay, etc.), the wireless device may include multiple PD values and/or distributions for the second technology stored in the memory (e.g., memory 240 of FIG. 2). Each of the PD values or distributions may correspond to a respective one of multiple transmit scenarios supported by the wireless device for the second technology. The transmit scenarios may correspond to various combinations of radios (e.g., radio(s) 250 of FIG. 2), communication technologies (e.g., RAT(s)), antennas (e.g., antenna(s) 218 of FIG. 2), antenna groupings, antenna configurations, SISO or MIMO transmissions, operating conditions (or modes), frequency bands, RF exposure scenarios (e.g., head exposure, body-worn exposure, extremity (hand) exposure, and/or hotspot exposure), device use-case scenarios (e.g., based on active applications on the device such as voice vs. data applications, gaming vs. video-call applications active on the device), physical configurations of a device (e.g., folded, closed, unfolded, open), and/or geographical locations or regions (e.g., countries or regions), as discussed further below. In some examples, the stored PD value and/or distribution includes a single value (e.g., a peak value determined based on the description below, or a sum of peak values).

The PD values and/or distribution (also referred to as a PD map) for each transmit scenario may be generated based on measurements (e.g., E-field measurements) performed in a test laboratory using a model of a human body. After generation, the PD values and/or distributions are stored in the memory to enable the processor (e.g., processor 210 of FIG. 2) to assess RF exposure in real time, as discussed further below. In certain aspects, each PD distribution may include a set of PD values, where each PD value may correspond to a different location of the wireless device exposing RF energy to the model of the human body, for example.

The PD values in each PD distribution correspond to a particular transmission power level (e.g., the transmission power level at which the PD values were measured in the test laboratory). Since PD scales with transmission power level, the processor may scale a PD value or distribution for any transmission power level by multiplying each PD value (e.g., in the PD distribution) by the following transmission power scaler:

$$\frac{{Tx}_{c}}{{Tx}_{PD}} \qquad ( 4 )$$

where Tx_{c} is a current transmission power level for the respective transmit scenario, and Tx_{PD} is the transmission power level corresponding to the PD values (e.g., the transmission power level at which the PD values were measured in the test laboratory).

As discussed above, the wireless communication device may support multiple transmit scenarios for the second technology. In certain aspects, the transmit scenarios may be specified by a set of parameters. The set of parameters may include, without limitation, one or more of the following: a radio parameter indicating one or more radios used for transmission (e.g., active radios), an antenna parameter indicating one or more antennas used for transmission (e.g., active antennas), a parameter indicating SISO transmission or MIMO transmission, a parameter(s) indicating a set of operating conditions, a frequency band parameter indicating one or more frequency bands used for transmission (e.g., active frequency bands), a channel parameter indicating one or more channels used for transmission (e.g., active channels), a body position parameter (e.g., a DSI) indicating the location of the wireless communication device relative to the user's body location (head, trunk, away from the body, etc.), exposure category, a parameter indicating at least one physical configuration of the wireless communication device, a parameter indicating a geographical location or region (e.g., PLMN code and/or a MCC), and/or other parameters. In cases where the wireless device supports a large number of transmit scenarios, it may be very time-consuming and expensive to perform measurements for each transmit scenario in a test setting (e.g., test laboratory). To reduce test time, measurements may be performed for a subset of the transmit scenarios to generate PD values and/or distributions for the subset of transmit scenarios. In this example, the PD values and/or distributions for each of the remaining transmit scenarios may be generated by combining two or more of the PD values and/or distributions for the subset of transmit scenarios, as discussed further below.

For example, PD measurements may be performed for each one of the antennas to generate a PD value or distribution for each one of the antennas. In this example, a PD value or distribution for a transmit scenario in which two or more of the antennas are active may be generated by combining the PD values or distributions for the two or more active antennas.

In another example, PD measurements may be performed for each one of multiple frequency bands to generate a PD value or distribution for each one of the multiple frequency bands. In this example, a PD value or distribution for a transmit scenario in which two or more frequency bands are active may be generated by combining the PD values or distributions for the two or more active frequency bands.

In certain aspects, a PD distribution may be normalized with respect to a PD limit by dividing each PD value in the PD distribution by the PD limit. In this case, a normalized PD value exceeds the PD limit when the normalized PD value is greater than one, and is below the PD limit when the normalized PD value is less than one. In these aspects, each of the PD distributions stored in the memory may be normalized with respect to a PD limit. Similarly, a single or individual PD value may be normalized with respect to a PD limit.

In certain aspects, the normalized PD value or distribution for a transmit scenario may be generated by combining two or more normalized PD values or distributions. For example, a normalized PD value or distribution for a transmit scenario in which two or more antennas are active may be generated by combining the normalized PD values or distributions for the two or more active antennas. For the case in which different transmission power levels are used for the active antennas, the normalized PD value or distribution for each active antenna may be scaled by the respective transmission power level before combining the normalized PD values or distributions for the active antennas. The normalized PD value or distribution for simultaneous transmission from multiple active antennas may be given by the following:

$${PD}_{norm \_ combined} = {\sum }_{i = 1}^{i = L} \frac{{Tx}_{i}}{{Tx}_{PDi}} \cdot \frac{{PD}_{i}}{{PD}_{lim}} \qquad ( 5 )$$

where PDₗᵢₘ is a PD limit, PD_{norm_combined} is the combined normalized PD value or distribution for simultaneous transmission from the active antennas, i is an index for the active antennas, PDᵢ is the PD value or distribution for the i^{th} active antenna, Txᵢ is the transmission power level for the i^{th} active antenna, Tx_{PDi} is the transmission power level for the PD distribution for the i^{th} active antenna, and L is the number of the active antennas.

Equation (5) may be rewritten as follows:

$${PD}_{norm \_ combined} = {\sum }_{i = 1}^{i = L} \frac{{Tx}_{i}}{{Tx}_{PDi}} \cdot {PD}_{norm \_ i} \qquad ( 6 a )$$

where PD_{norm_i} is the normalized PD value or distribution for the i^{th} active antenna. In the case of simultaneous transmissions using multiple active antennas at the same transmitting frequency (e.g., MIMO), the combined normalized PD value or distribution may be obtained by summing the square root of the individual normalized PD values or distributions and computing the square of the sum, as given by the following:

$${PD}_{norm \_ combined \_ MIMO} = {[ {\sum }_{i = 1}^{i = L} \sqrt{\frac{{Tx}_{i}}{{Tx}_{PD}} \cdot {PD}_{norm \_ i}} ]}^{2} . \qquad ( 6 b )$$

In another example, normalized PD values or distributions for different frequency bands may be stored in the memory. In this example, a normalized PD value or distribution for a transmit scenario in which two or more frequency bands are active may be generated by combining the normalized PD distributions for the two or more active frequency bands. For the case where the transmission power levels are different for the active frequency bands, the normalized PD value or distribution for each of the active frequency bands may be scaled by the respective transmission power level before combining the normalized PD values or distributions for the active frequency bands. In this example, the combined PD value or distribution may also be computed using Equation (6a) in which i is an index for the active frequency bands, PD_{norm_i} is the normalized PD value or distribution for the i^{th} active frequency band, Txᵢ is the transmission power level for the i^{th} active frequency band, and Tx_{PDi} is the transmission power level for the normalized PD value or distribution for the i^{th} active frequency band.

### Example RF Exposure Compliance

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the FCC specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands).

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum output or transmit power that can be used by the wireless device.

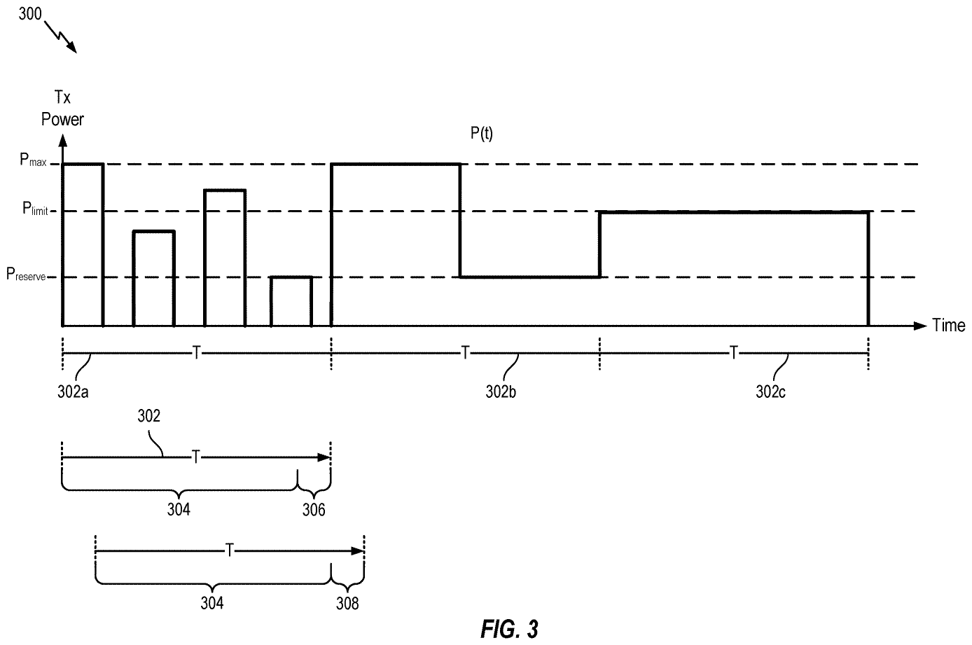

FIG. 3 is a graph 300 of a transmit power over time (P(t)) that varies over a running (e.g., rolling or moving) time window (T) associated with the RF exposure limit. The wireless device (e.g., the wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, such as in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the time window 302c such that the time-averaged transmit power over the time window (e.g., the time window 302c) is equal to Pₗᵢₘᵢₜ in compliance with the time-averaged RF exposure limit. The RF exposure level corresponding to time-averaged transmit power limit (Pₗᵢₘᵢₜ) may be referred to as an RF exposure design target. The RF exposure design target may be less than or equal to the RF exposure limit. The RF exposure design target may be selected to be less than the RF exposure limit to account for device uncertainty and/or to meet the RF exposure limit in exposure scenarios when transmitting simultaneously with other radios within the same device that have a different RF exposure controlling mechanism.

In certain cases, an instantaneous transmit power may exceed Pₗᵢₘᵢₜ in certain transmission occasions, for example, as shown in the time window 302a and the time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, PCMAX). In some cases, the wireless device may transmit at a transmit power less than or equal to Pₗᵢₘᵢₜ in certain transmission occasions, for example, as shown in the time window 302a.

In certain cases, a reserve power may be used to enable a continuous transmission within a time window (T) when transmitting above Pₗᵢₘᵢₜ in the time window or to enable a certain level of quality for certain transmissions. As shown in the time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 302 for certain transmissions (e.g., control signaling). Pᵣₑₛₑᵣᵥₑ may also be referred to as a “control power level” or “control level.”

In the time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the area of transmit power (P(t)) in the time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-averaged mode illustrated in the time window 302b. While a single transmit burst is illustrated in the time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 5 milliseconds (ms)) of a specific period (e.g., 500 ms) in which the wireless device transmits RF signals. The duty cycle may be a ratio of the share to the specific period (e.g., 100 ms/500 ms), where the duty cycle may be represented as a number from zero to one. For example, in the time window 302a, the duty cycle may be greater than 50% of the duration of the time window (T), whereas in the time window 302b, the duty cycle may be equal to 100% of the duration of the time window (T).

In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

In some cases, a controller (e.g., a WWAN modem) may control the RF exposure exhibited by WWAN radios in addition to other radios (e.g., RFID radio(s), WLAN radio(s) and/or Bluetooth radio(s)). For example, in some such configurations, the controller may implement the RF exposure manager 106.

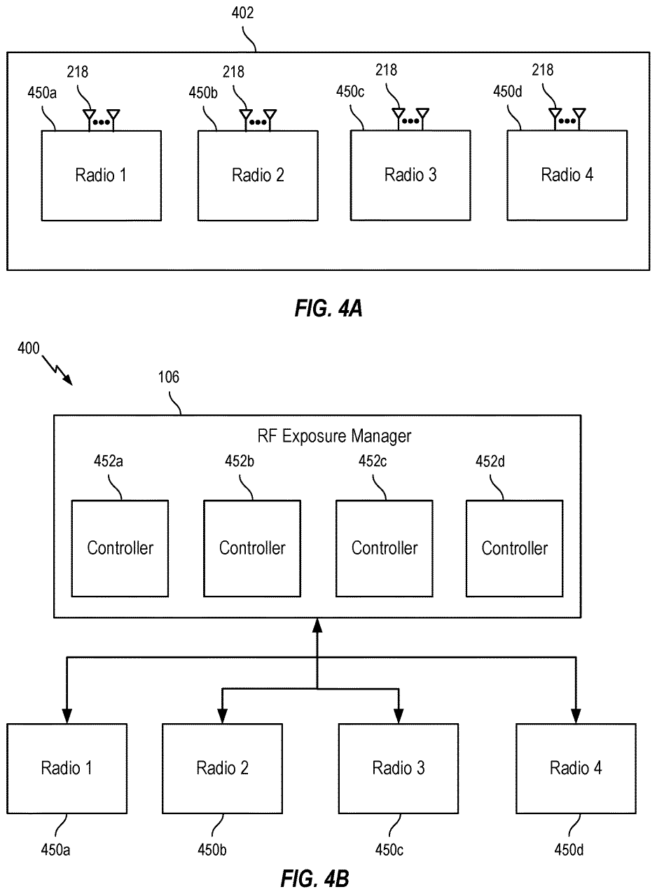

FIG. 4A is a diagram illustrating an example wireless device 402 (e.g., the wireless device 102) having multiple radios 450a-450d (collectively, “the radios 450”). The radios 450 may be similar to the radio(s) 250 of the wireless device 102 depicted in FIG. 2. In the example depicted in FIG. 4A, the radios 450a-450d may be associated with any of various RATs and/or frequency bands. For example, the radio 450a (or radio 1) may communicate via WWAN RAT(s) (e.g., E-UTRA and/or 5G NR) in sub-6 GHz frequency bands. The radio 450b (or radio 2) may communicate via RFID RAT(s) in sub-6 GHz frequency bands. The radio 450c (or radio 3) may communicate via WLAN RAT(s) in sub-6 GHz (e.g., 2.4 GHz, 5 GHz, and/or 6 GHz) frequency bands. The radio 450d (or radio 4) may communicate via short-range communications (e.g., Bluetooth) in a 2.4 GHz frequency band. While this example shows a wireless device having four radios, a wireless device may have any number of radios for wireless communications, such as a radio per frequency band associated with RFID, WWAN and/or WLAN communications, a radio per RAT, or a radio capable of communicating via multiple RATs, as illustrative, non-limiting examples. Further, while the radios are illustrated as being separate, two or more of the radios may share components or circuitry. For example, portions of a signal path may be shared. The shared portion may include a shared or common mixer, filter, amplifier, and/or ADC or DAC, etc.

FIG. 4B is a diagram illustrating an example logical architecture 400 for controlling the transmit power (and hence, the RF exposure) associated with one or more radios (e.g., the radios 450a-450d) of a wireless device (e.g., the wireless device 402). The RF exposure manager 106 may operate as a primary controller for controlling the RF exposure associated with the radios 450a-450d. The primary controller may be a central controller for determining the maximum allowed transmit powers and/or transmit duration that can be used for a future time interval based on past transmit powers associated with all of the radios 450a-450d. For example, the RF exposure manager 106 may periodically (e.g., every 500 ms) receive certain information from the radios 450a-450d, where the information may include, for example, a requested transmit power or exposure margin for a future time interval (e.g., the time interval 306, 308) and/or past transmit power history associated with a time interval (e.g., the past time interval 304) and/or averaging time window (e.g., the time window 302) or indication of whether a radio was on (active) or transmitting during the time interval and/or averaging time window. The RF exposure manager 106 may periodically (e.g., every 500 ms) provide each of the radios with an RF exposure margin or maximum allowed transmit power as well as a transmit duration for a future time interval (e.g., the future time interval 306, 308).

The primary controller may include any of a number of controllers (e.g., the controller 452a, the controller 452b, and/or the controller 452c). The controller 452a may represent the WWAN modem, the controller 452b may represent the WLAN modem, the controller 452c may represent the Bluetooth modem, and the controller 452d may represent the RFID modem, for example. Thus, while the controllers 452 are illustrated separate from the radios 450, the controllers 452 and/or certain functionality thereof may be included within or integrated with respective radios 450. The controllers 452 are illustrated as being within the RF exposure manager 106, but one or more of the controllers 452 may be implemented external to the RF exposure manager 106. Further, while certain of the controllers 452 are described as being associated with or configured to implement functionality of a particular radio and/or RAT, one or more of the controllers 452 may be agnostic with respect to radios and/or RATs, and/or may be shared by multiple radios. For example, a controller 452 may be included in an applications processor.

In some cases, a controller may take control of its own power limit and operate in a standalone manner (or mode) in response to the primary controller being in a particular state (e.g., idle mode, inactive, sleep mode, low power state, etc.). For example, when the controller 452a switches to a sleep or idle mode (e.g., due to the wireless device switching to reduced power mode), the controller 452b may operate in a standalone mode controlling the RF exposure associated with the radio 450c, and in some cases, the controller 452c may operate in standalone mode controlling the RF exposure associated with the radio 450d.

The primary controller (e.g., the controller 452a) may provide the other controllers 452b, 452c, 452d with certain information. For example, the primary controller may indicate to the other controllers that the primary controller is going to a state where the primary controller can no longer operate as the primary controller (for a particular or indefinite time). Additionally, the primary controller may indicate to the other controllers a respective transmit power budget (e.g., RF exposure budget or RF exposure margin) and/or transmit duration that applies for the radio(s) and/or RAT(s) while the primary controller is unable to operate as the primary controller (e.g., for the particular or indefinite time). The transmit power budget and/or transmit duration may be allocated to each radio and/or RAT in a manner to ensure compliance with the RF exposure limit. In general, the cumulative target powers associated with the radio(s) and/or RAT(s) may satisfy the RF exposure limit. For example, the controller 452b (and/or radio(s) 450 associated therewith) may be allocated 30% of the RF exposure budget for a given time window, the controller 452c (and/or radio(s) 450 associated therewith) may be allocated 40% of the RF exposure budget for the time window, and the controller 452d (and/or radio(s) 450 associated therewith) may be allocated 30% of the RF exposure budget for a given time window.

The primary controller may instruct the other controllers to use specific RF exposure calculations—for example, an RF exposure compliance algorithm (e.g., time-averaging or a particular maximum transmit power) with a preset parameter (e.g., RF exposure budget or transmit power level)—to control each of the other controllers' own power limits in a standalone manner. The RF exposure compliance algorithm may be the same or different among the controllers. For example, the complexity of the algorithms or calculations may be considered when instructing the controllers. It may be unnecessary for certain controllers to evaluate the same number of and/or type of criteria, and/or the controllers may have varying capabilities.

### Example Transmit Antenna Grouping

In certain cases, the wireless device may evaluate RF exposure compliance in terms of one or more antenna groups, where an antenna group may be a collection of antennas and/or antenna modules. The antenna groups may be treated mutually exclusive of each other in terms of RF exposure. For example, the wireless device may evaluate the RF exposure compliance for an antenna group independently of the RF exposure compliance for another antenna group. The antenna groups may be static or dynamic. The antennas and/or antenna modules may support multiple RATs.

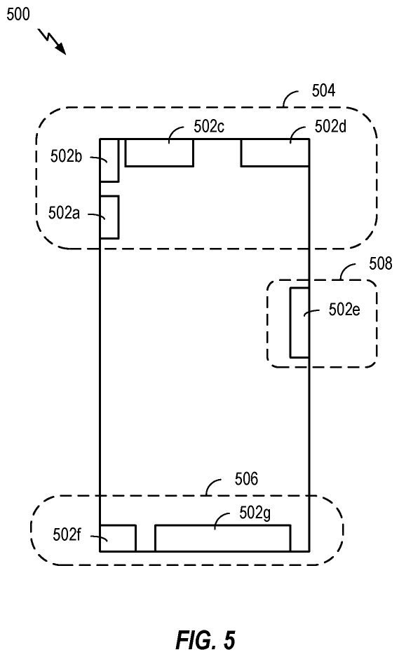

FIG. 5 is a block diagram illustrating an example grouping of multiple antennas of a wireless device 500, in accordance with certain aspects of the present disclosure. In this example, the wireless device 500 (e.g., a UE 120, such as a smartphone, or any of the wireless communication devices described herein) includes a first antenna 502a, a second antenna 502b, a third antenna 502c, a fourth antenna 502d, a fifth antenna 502e, a sixth antenna 502f, and a seventh antenna 502g. In this example, the antennas 502a-502g are separated into three antenna groups 504, 506, 508, which roughly correspond to a top of the device 500, a bottom of the device 500, and a side of the device 500, when the device 500 is held in the upright position. Those of skill in the art will appreciate that more or less than seven antennas may be implemented, and/or more or less than three antenna groupings may be defined. Each of the illustrated antennas 502a-502g may represent a single antenna, an array (e.g., a phased array) of antennas, or a module including one or more antennas. The antenna groups 504, 506, 508 may each include one or more antennas that are configured to transmit in a certain frequency band (e.g., very high (e.g., mmWave bands), high (e.g., 6-7 GHz bands), medium (e.g., 3-6 GHz bands), or low (e.g., 400 MHz-3 GHz bands)), or the antenna groups may each include one or more antennas that are configured to transmit in multiple frequency bands.

The antenna groupings described herein may be assigned into various antenna groupings (such as a mmWave grouping, a sub-6 GHz grouping, a low band grouping (e.g., 400 MHz-3 GHz bands), a mixed-mode grouping (e.g., mmWave and sub-6 GHz grouping), a multi-RAT grouping (e.g., RFID, WWAN and WLAN), groupings for different exposure scenarios and/or device positions relative to the user's body, etc.), for example, for differing transmit scenarios. As an example, under a mmWave grouping, each mmWave module (e.g., the first antenna 502a, the third antenna 502c, and the fifth antenna 502e) may be treated as a separate antenna group, where each mmWave module may have multiple antenna elements (e.g., 4, 5, 8, 10, etc. dual polarization antenna elements) arranged in one or more arrays. The mmWave module may be capable of transmitting various beams via predefined antenna configurations, where the beams may form a codebook. Under a sub-6 GHz grouping, sub-6 GHz antennas may be grouped into separate groups. For example, the second and fourth antennas 502b, 502d may be assigned to a group, and the sixth and seventh antennas 502f, 502g may be assigned to another group. In certain cases, the antennas 502a-502g may be assigned to a mixed-mode grouping, such as the three antenna groups 504, 506, 508. Each antenna may be included in a separate antenna group, as illustrated, or one or more antennas may be included in multiple antenna groups.

The antenna groups may be defined and/or operated so as to be mutually exclusive in terms of RF exposure. In certain aspects, the transmit power of one or more of the antenna groups (or of one or more of the antennas within one or more groups) may be reduced such that the (normalized) sum of the exposure of all antenna groups, or of the overlapped RF exposure distributions, is less than a particular value (e.g., 1.0). For example, backoff factors may be determined for one or more groups, or one or more antennas within one or more groups, and applied so as to limit transmission power for the antenna(s) and/or groups. In certain aspects, antennas in different antenna groups are far enough away from each other such that the antennas' exposures do not overlap in the range in which exposure to a user is measured or defined. In certain aspects, existing regulatory approaches that meet predefined criteria like SAR peak location separation ratio (SPLSR) may be used to determine such mutual exclusivity (for example, as described in Section 4.3.2c of the FCC Knowledge Database (KDB) 447498 D01 General RF Exposure Guidance v06). The mutual exclusivity of the antenna groups may enable the RF exposure manager 106 to determine the time-averaged RF exposures for each of the antenna groups in parallel with (e.g., independent of) each other.

In some examples, antenna groups for a device (e.g., the wireless device 102) are defined in documents presented to and/or published by a regulatory body during the process of demonstrating or certifying that the device complies with RF exposure regulations.

The antenna groups are static in some examples. In other examples, the antenna groups change over time or based on the scenario.

### Example RF Exposure Contribution Information

In certain cases, although antennas may be positioned in different locations across a wireless device, a time-averaging algorithm for RF exposure compliance may assume the peak locations of RF exposure (also referred to as RF exposure hotspots) from all transmit antennas are collocated on the wireless device. Under such an assumption, the total transmit power of all transmit antennas may be limited regardless of the actual exposure scenario (e.g., head exposure, body exposure, or extremity exposure) of separate antennas. For example, suppose the user's hand covers one location on the wireless device, while RF exposure hotspots from specific antennas are not covered by the user's hand. That is, antennas may contribute to the RF exposure differently depending on the location of the exposure. Enforcing the collocated model may lead to limiting the transmit power of specific antennas whose RF exposure hotspots are not actually covered by the user's hand. That is, the assumption that all RF exposure hotspots from transmit antennas are collocated for RF exposure compliance may result in a needlessly low transmit power, which may affect uplink performance such as uplink data rates, uplink carrier aggregation, and/or an uplink connection at the edge of a cell.

Similarly, in cases where antennas are grouped into one or more antenna groups, a time-averaging algorithm for RF exposure compliance may assume all RF exposure hotspots from transmit antennas within a given antenna group are collocated. Under such an assumption, the total transmit power of all transmit antennas within the antenna group may be limited regardless of the actual exposure scenario of separate antennas within the antenna group. For example, the peak locations of RF exposure may not be at the same location for all antennas of an antenna group. Accordingly, enforcing the collocated model for an antenna group may also lead to limiting the transmit power of specific antennas within the antenna group. That is, the assumption that all RF exposure hotspots from transmit antennas within the antenna group are collocated for RF exposure compliance may result in a needlessly low transmit power, which may affect uplink performance such as uplink data rates, uplink carrier aggregation, and/or an uplink connection at the edge of a cell.

In certain examples, a time-averaged RF exposure evaluation that assumes all (or at least some) RF exposure hotspots of antennas are collocated may be represented with the following:

$$total . RF . exp = max \{ \frac{1}{T} {\int }_{t - T}^{t} \sum [ RF . exp . ( {Ant}_{i} , t ) , ∀ {Ant}_{i} ∈ device ] dt \} \qquad ( 7 )$$

where T is the operating time-averaging window, RF. exp. (Antᵢ, t) is the RF exposure for the i^{th} antenna (k antennas, i=1, 2, . . . , k), and total.RF.exp is the total RF exposure for antennas of the device within the operating time-averaging window T.

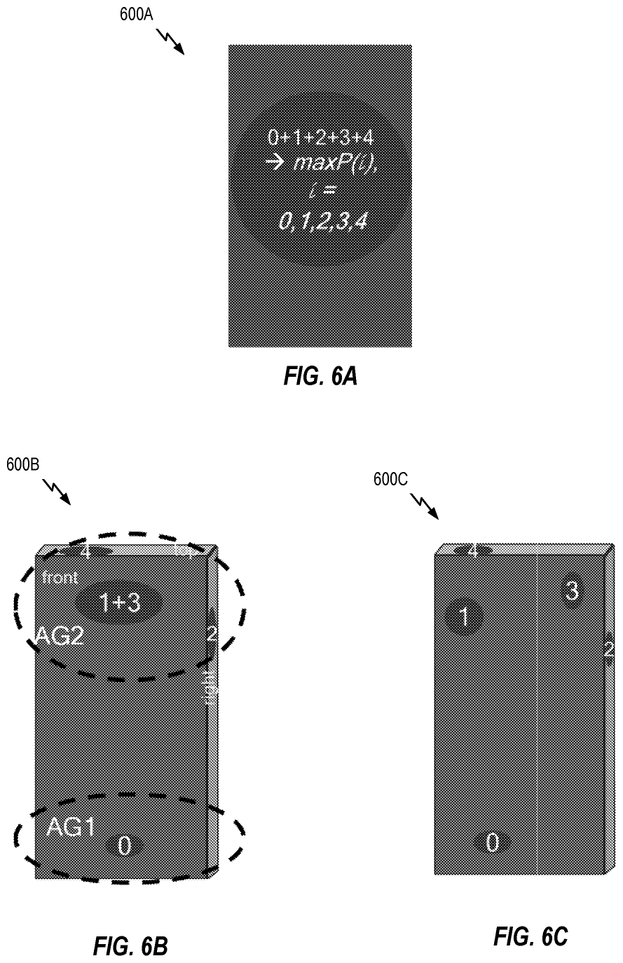

By way of example, consider FIG. 6A, which illustrates an example time-averaged exposure evaluation for a wireless device 600A that is performed according to Equation 7. In this example, the wireless device 600A (e.g., a UE 120, such as a smartphone, or any of the wireless communication devices described herein) includes five antennas (antennas 0, 1, 2, 3, and 4). Those of skill in the art will appreciate that more or less than five antennas may be implemented. Each of the illustrated antennas on the wireless device 600A may represent a single antenna, an array (e.g., a phased array) of antennas, or a module including one or more antennas. For the wireless device 600A, the time-averaged RF exposure evaluation may assume that all (or at least a portion of) RF exposure hotspots for the five antennas are on the same surface and collocated.

In certain examples, a time-averaged RF exposure that assumes all (or at least some) RF exposure hotspots of antennas within a given antenna group are collocated may be represented with the following:

$$total . RF . exp ( {AG}_{j} ) = max \{ \frac{1}{T} {\int }_{t - T}^{t} \sum [ RF . exp . ( {Ant}_{i} , t ) , ∀ {Ant}_{i} ∈ {AG}_{j} ] dt \} \qquad ( 8 )$$

where T is the operating time-averaging window, RF. exp. (Antᵢ, t) is the RF exposure for the i^{th} antenna (k antennas, i=1, 2, . . . , k) within the j^{th} antenna group (m antenna groups, j=1, 2, . . . , m) and total.RF.exp(AGⱼ) is the total RF exposure for j^{th} antenna group for the device within the operating time-averaging window T.

By way of example, consider FIG. 6B, which illustrates an example time-averaged exposure evaluation for a wireless device 600B that is performed according to Equation 8. In this example, the wireless device 600B (e.g., a UE 120, such as a smartphone, or any of the wireless communication devices described herein) includes five antennas (antennas 0, 1, 2, 3, and 4) separated into two antenna groups AG1 and AG2. AG2, which roughly corresponds to a top of the device 600B when the device 600B is held in the upright position, includes antennas 1, 2, 3, and 4. AG1, which roughly corresponds to a bottom of the device 600B when the device 600B is held in the upright position, includes antenna 0. Top and bottom, as used here, describe groupings of antennas, and are not representative of the location of the hotspots. Those of skill in the art will appreciate that more or less than five antennas may be implemented, and/or more or less than two antenna groups may be defined. Each of the illustrated antennas on the wireless device 600B may represent a single antenna, an array (e.g., a phased array) of antennas, or a module including one or more antennas. For the wireless device 600B, the time-averaged RF exposure evaluation may assume that all (or at least a portion of) RF exposure hotspots within each of AG1 and AG2 are on the same surface and collocated.

Aspects of the present disclosure provide various techniques for determining RF exposure contribution information associated with antennas of a wireless device. The RF exposure contribution information may include, for each antenna, an indication of spatial contribution of RF exposure from the antenna on one or more RF exposure contributors. In some cases, the RF exposure contributor(s) may include each other antenna of the wireless device. In other cases, the RF exposure contributor(s) may include one or more composite RF exposure maps for one or more antennas of the wireless device. In other cases, the RF exposure contributor(s) may include one or more regions of an RF exposure distribution (or map) for the wireless device. In yet other cases, the RF exposure contributor(s) may include one or more surfaces of the wireless device.

In certain aspects, the indications of spatial RF exposure contributions for each antenna may be represented with an RF exposure contribution matrix, which includes a respective contribution factor (or contribution ratio) corresponding to a level of interaction of RF exposure from the antenna on one of the RF exposure contributor(s).

In certain aspects, the RF exposure contribution information may be determined using a trained machine learning model, such as a neural network, that has been trained to predict spatial contributions of RF exposure based on antenna configurations, operating conditions, and/or historical RF exposure data. The trained machine learning model may receive as input information indicating antenna locations, antenna configurations, frequency bands, and/or transmit power levels, and may output RF exposure contribution information indicating spatial contribution of RF exposure from each antenna on one or more RF exposure contributors.

In certain aspects, assuming a wireless device has n antennas, the contribution matrix for each antenna may be a n-by-n square matrix. Each contribution matrix may be based on spatial information obtained from RF exposure distributions associated with the antennas and/or information indicating spatial separation distances between the antennas.

In certain aspects, assuming a wireless device has n antennas and the RF exposure contributors are representative of regions of an RF exposure map, the contribution matrix may be an n-by-m matrix, where m is the # of regions of the RF exposure map.

In certain aspects, assuming a wireless device has n antennas and m surfaces, the contribution matrix may be a n-by-m matrix, where m is the # of surfaces of the wireless device.

In certain aspects, a time-averaged RF exposure evaluation that accounts for the RF exposure hotspots of antennas using the respective RF exposure contribution information for the antennas may be represented with the following:

$$total . RF . exp ( x , y , z ) = max \{ \frac{1}{T} {\int }_{t - T}^{t} \sum [ RF . exp . ( {Ant}_{i} , x , y , z , t ) , ∀ {Ant}_{i} ∈ device ] dt \} \qquad ( 9 )$$

where T is the operating time-averaging window, RF. exp. (Antᵢ,x, y, z, t) is the RF exposure for the i^{th} antenna (k antennas, i=1, 2, . . . , k) per location (x, y, z) at time instant t and total.RF.exp(x,y,z) is the total RF exposure per location (x, y, z) within the operating time-averaging window T Here, RF. exp. (Antᵢ, x, y, z, t) may be determined based on RF exposure contribution information, which may indicate spatial contribution of RF exposure from the i^{th} antenna on one or more RF exposure contributors.

By way of example, consider FIG. 6C, which illustrates an example time-averaged exposure evaluation for a wireless device 600C that is performed according to Equation 9. In this example, the wireless device 600C (e.g., a UE 120, such as a smartphone, or any of the wireless communication devices described herein) includes five antennas (antennas 0, 1, 2, 3, and 4). Those of skill in the art will appreciate that more or less than five antennas may be implemented. Each of the illustrated antennas on the wireless device 600C may represent a single antenna, an array (e.g., a phased array) of antennas, or a module including one or more antennas. For the wireless device 600C, the time-averaged RF exposure evaluation may account for the RF exposure hotspot(s) of each antenna 0 to antenna 4 using respective RF exposure contribution information for each antenna 0 to antenna 4.

In certain aspects, performing a time-averaged RF exposure evaluation using the RF exposure contribution information (e.g., according to Equation 9) may involve performing an RF exposure assessment of past RF exposure over a given time window using the RF exposure contribution information described herein to determine a maximum allowable transmit power for a future time interval in the time window. The time-averaged operation may track a normalized RF exposure history over the time window for each radio, and the wireless device may sum the normalized RF exposures of all active radios in simultaneous transmission scenarios. The sum of normalized RF exposure associated with the radios may use the respective RF exposure contribution associated with each of the antenna(s) for the radios.

In certain cases, compared to performing a time-averaged RF exposure evaluation according to Equation 7 or according to Equation 8, performing the time-averaged RF exposure evaluation based on the spatial information of RF exposure contributions among antennas (e.g., according to Equation 9) may provide a more accurate assessment of the RF exposure occurring at locations across the wireless device, allowing the wireless device to determine a higher maximum allowable transmit power limit for certain transmissions.

### Example Time-Averaged RF Exposure Evaluation with Tissue Registration

Certain time-averaged RF exposure evaluations, such as those performed according to any one of Equations 7, 8, and 9, may assume that human tissue is present across all locations (or regions) on the wireless device for the entire duration (or at least a portion) of the time window (e.g., time-averaging window). By way of example, each of the time-averaged RF exposure evaluations illustrated in FIGS. 6A, 6B, and 6C may assume that human tissue is present everywhere on the respective devices 600A, 600B, and 600C for an entire duration (or at least a portion) of the time window. That is, the time-averaged RF exposure evaluations illustrated in FIGS. 6A, 6B, and 6C may assume that all hotspots are exposing RF energy to human tissue for the entire duration (or at least a portion) of the time window. Consequently, the time-averaged RF exposure evaluations illustrated in FIGS. 6A, 6B, and 6C may not take into account whether tissue (and, in some cases, the type of tissue that) is actually being exposed to RF energy from a given location (or region) on the wireless device.

To address this, certain aspects described herein provide techniques for performing time-averaged RF exposure evaluation for one or more locations across a wireless device based in part on sensor information indicating whether human tissue is present for the one or more locations (e.g., tissue presence at and/or surrounding the one or more locations). For example, the time-averaged RF exposure evaluation may involve determining and/or tracking (i) presence of one or more human tissues corresponding to one or more locations across the wireless device over time and (ii) RF exposure associated with the one or more locations over time. The time-averaged RF exposure evaluation may further involve determining a transmit power for a time window based at least in part on the tracked RF exposure and the tracked presence of human tissues, in compliance with an RF exposure limit. The wireless device may transmit a signal, via one or more antennas, during the time window, based in part on the determined transmit power.

The apparatus and techniques for implementing RF exposure compliance based on sensor information indicating presence of tissue corresponding to various locations on the wireless device, as described herein, may enable desirable transmit power for specific radios, antennas, beams, and/or antenna groups, for example, due to differing exposure encountered by each. The desirable transmit power may provide desirable wireless communication performance, such as increased data rates, reduced latency, and/or increased transmission range, as illustrative examples.

In certain aspects, the wireless device may be configured with, or otherwise associated with, one or more sensors configured to determine whether human tissue is present at and/or surrounding a given location on the wireless device. In certain examples, the one or more sensors may include one or more touch sensors. Such touch sensors may be implemented using various different types of touch sensors, including, but not limited to, capacitive touch sensors, resistive touch sensors, infrared (IR) touch sensors, ultrasonic touch sensors, optical touch sensors, and hover touch sensors, among others.

Additionally or alternatively, the one or more sensors may include multiple different types of sensors. For example, a first sensor type (e.g., touchscreen sensor) may generate first sensor information indicating whether human tissue (e.g., finger(s)) is touching the wireless device, and a second sensor type (e.g., thermal sensor) may generate second sensor information indicating whether human tissue (e.g., palm) is touching the wireless device. In this example, the wireless device (via a processor and/or controller and/or sensor circuitry) may combine the first sensor information and the second sensor information in order to generate sensor information indicating whether human tissue is present for a given location on the wireless device.

The one or more sensors may be arranged in various locations on the wireless device, including particular areas/regions on the wireless device, particular surfaces on the wireless device (e.g., top surface, bottom surface, side surfaces, front surface, back surface, etc.), antenna locations, RF exposure hotspots associated with one or more antennas of the wireless device, among others. The sensors may be arranged in any suitable configuration or manner, including grid configuration, spiral configuration, diagonal configuration, an irregular configuration (seeming more random than being according to a pattern), among others. In some cases, the spacing between sensors may be uniform or non-uniform.

In certain aspects, the sensor information provided by the one or more sensors may indicate whether tissue is present for a given location on the wireless device (e.g., tissue is present at and/or surrounding the given location on the wireless device). For example, the sensor information may include (or otherwise indicate), for each location (x, y, z), tissue mask(x,y,z,t)=‘1’ when tissue is present for the location (x, y, z) at time instance t or tissue mask(x,y,z,t)=‘0’ when tissue is absent for the location (x, y, z) at time instance t.

In addition to, or as an alternative to, indicating whether tissue is present for a given location on the wireless device, in certain aspects, the sensor information provided by the one or more sensors may indicate a type of tissue that is present for a given location on the wireless device. For example, the one or more sensors may be configured to detect whether a particular tissue ID (e.g., tissue.ID1 for head, tissue.ID2 for face, tissue.ID3 for left arm, etc.) is present for a given location, and output sensor information that includes an indication of the tissue ID(s) that is present for a given location over time. Here, each tissue ID may represent one area of a human body (e.g., left side of head) or may represent multiple areas of human body (e.g., left and right arms). In such aspects, the sensor information may include (or otherwise indicate), for each location (x, y, z), tissue.maskₖ(x,y, z, t)=‘1’ when tissueₖ is present for the location (x, y, z) at time instance t or tissue.maskₖ (x, y, z, t)=‘0’ when tissueₖ is absent for the location (x, y, z) at time instance t.

As noted, in certain aspects, in addition to tracking presence of tissue for various locations on the wireless device across time, the time-averaged RF exposure evaluation may also track RF exposure for the various locations on the wireless device across time. In such aspects, the RF exposure at each location may be determined and/or tracked using RF exposure contribution information associated with the location, as described herein. In certain aspects, in addition to, or as an alternative to, determining RF exposure contribution information associated with antennas (e.g., one or more critical regions) of a wireless device, the RF exposure contribution information may be determined (more generally) for each of one or more locations (or regions) on the wireless device. Such locations may include critical regions (e.g., peak locations of RF exposure and surrounding regions above a certain threshold of RF exposure) as well as non-critical regions (e.g., locations on the wireless device a threshold distance away from peak locations of RF exposure, or locations on the wireless device that have RF exposure amplitude below a threshold percentage of peak amplitude of RF exposure). In an illustrative example of non-critical regions, assuming amplitudes below 10% threshold of peak exposure are not relevant for RF exposure, then the non-critical regions may include all locations on the wireless device that have exposure between 0% and 10% of peak exposure. Note, however, that a 10% threshold is merely an example and that other threshold values may be used to determine non-critical regions.

In some examples, the RF exposure contribution information may include, for each location, an indication of spatial contribution of RF exposure from the location on one or more RF exposure contributors. In some cases, the RF exposure contributor(s) may include each other antenna location of the wireless device. In other cases, the RF exposure contributor(s) may include one or more composite RF exposure maps for one or more locations across the wireless device. In other cases, the RF exposure contributor(s) may include one or more regions of an RF exposure distribution (or map) for the wireless device. In yet other cases, the RF exposure contributor(s) may include one or more surfaces of the wireless device.

In certain aspects, performing a time-averaged RF exposure evaluation based on the tracked RF exposure and the tracked presence of human tissues for one or more locations across the wireless device may involve overlaying the sensor information with the RF exposure contribution information in order to determine total RF exposure per location over a time window.

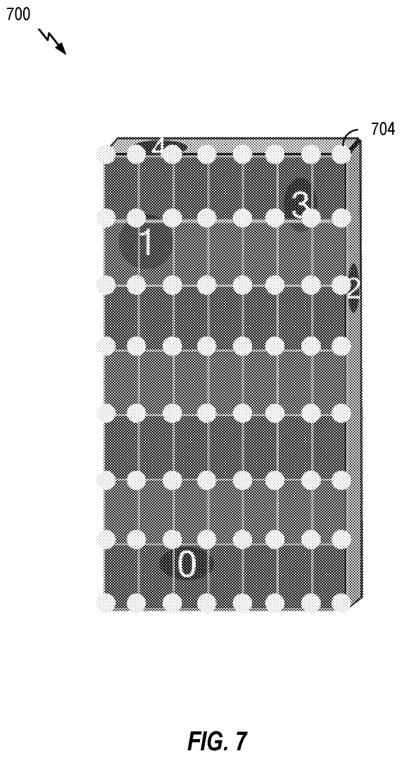

By way of example, FIG. 7 illustrates an example time-averaged exposure evaluation for a wireless device 700 that is performed based in part on sensor information indicating presence of tissue or tissue registration for one or more locations across the wireless device 700, according to certain aspects described herein. In this example, the wireless device 700 (e.g., a UE 120, such as a smartphone, or any of the wireless communication devices described herein) includes five antennas (antennas 0, 1, 2, 3, and 4). Those of skill in the art will appreciate that more or less than five antennas may be implemented. Each of the illustrated antennas on the wireless device 700 may represent a single antenna, an array (e.g., a phased array) of antennas, or a module including one or more antennas.

For the wireless device 700, sensor information (marked by nodes 704) is overlaid with RF exposure contribution information in order to evaluate the time-averaged RF exposure per location, as described further herein. Although the sensor information is shown as being provided for each node 704 for sake of clarity, it should be noted that the sensor information may be provided for greater or fewer number of nodes 704. Additionally, although the nodes 704 depicted in FIG. 7 are arranged on the front surface of device 700 in a grid with uniform spacing, it should be noted that the nodes 704 may be located on other surfaces of the device 700, may be arranged in other configurations (e.g., spiral, diagonal, diamond, etc.), and/or may have any combination of uniform and non-uniform spacing.

Additionally, note that, in certain aspects, one or more of the nodes 704 may not only represent tissue presence at a particular location (x, y, z), but also in a surrounding region of the node 704 depending on the sensing capability/range of the sensors in use (e.g., sensor resolution), the type of sensors, calibration of the sensors for triggering detection of tissue presence, the number of sensors, and/or the relative spacings between the sensors, among other parameters. In such aspects, the tissue mask for location (x, y, z) (e.g., tissue mask(x,y,z,t) or tissue.maskₖ(x, y, z, t)) may be representative of tissue presence at the specific location (x, y, z) as well as an area or volume surrounding the location (x, y, z). Similarly, the size of the surrounding region of the node 704 in which tissue presence is detected may be based the sensing capability/range of the sensors in use (e.g., sensor resolution), the type of sensors, calibration of the sensors for triggering detection of tissue presence, the number of sensors, and/or the relative spacings between the sensors, among other parameters. In some such aspects, the surrounding region may be indicated with at least three coordinates ((x₁, y₁, z₁), (x₂, y₂, z₂), (x₃, y₃, z₃)) that define the area/volume encompassed by the surrounding region. The surrounding region may have any suitable shape, such as a polygonal shape and elliptical shape (e.g., circle), as illustrative examples.

Additionally, in certain aspects, the surrounding region associated with the one or more of the nodes 704 may vary across the wireless device. For example, one or more sensors for a front surface of the wireless device may have a higher resolution than one or more sensors for a back surface of the wireless device (e.g., the wireless device may have different types of sensors for the front and back surfaces), there may be a greater number of sensors for the front surface than the back surface, etc.

In certain aspects, performing a time-averaged RF exposure evaluation for each node 704 on the wireless device 700 may involve determining the RF exposure at and/or surrounding the node 704 (e.g., determining RF exposure at one or more locations across the wireless device), based on the presence of human tissue at and/or surrounding the node 704 (e.g., tissue presence at one or more locations across the wireless device) (using the following Equation 10) or based on the presence of a particular (or unique) tissue ID at and/or surrounding the node 704 (e.g., presence of tissue ID at one or more locations across the wireless device) (using the following Equation 11).

The total RF exposure at and/or surrounding a particular node may be represented by the following:

$$total . RF . exp ( x , y , z ) = max \{ \frac{1}{T} {\int }_{t - T}^{t} \sum [ tissue . mask ( x , y , z , t ) * RF . exp . ( {Ant}_{i} , x , y , z , t ) , ∀ {Ant}_{i} ∈ device ] dt \} \qquad ( 10 )$$

where T is the operating time-averaging window, tissue.mask(x, y, z, t) is the tissue mask indicating whether tissue is detected at and/or surrounding location (x, y, z) at time instance t, RF. exp. (Antᵢ, x, y, z, t) is the RF exposure for the i^{th} antenna (k antennas, i=1, 2, . . . , k) per location (x, y, z) and total.RF.exp(x, y, z) is the total RF exposure at and/or surrounding location (x, y, z) within the operating time-averaging window T Here, RF. exp. (Antᵢ, x, y, z, t) may be determined based on RF exposure contribution information, which may indicate one or more RF exposure contributors for the location (x, y, z). Note that the tissue mask tissue.mask(x, y, z, t) may change with time (e.g., due to tissue movement). Here, tissue.mask(x, y, z, t)=1 if tissue is detected at and/or surrounding location (x, y, z) at time instance t, and tissue.mask(x, y, z, t)=0 if tissue is not detected at and/or surrounding location (x, y, z) at time instance t.

The total RF exposure for a particular tissue (e.g., tissueₖ) may be represented by the following:

$$total . RF . exp ( {tissue}_{k} ) = max \{ \frac{1}{T} {\int }_{t - T}^{t} \sum [ tissue . {mask}_{k} ( x , y , z , t ) * RF . exp . ( {Ant}_{i} , x , y , z , t ) , ∀ {Ant}_{i} ∈ device ] dt \} \qquad ( 11 )$$

where T is the operating time-averaging window, tissue.maskₖ(x, y, z, t) is the tissue mask indicating whether tissueₖ is detected at and/or surrounding location (x, y, z) at time instance t, RF. exp. (Antᵢ, x, y, z, t) is the RF exposure for the i^{th} antenna (k antennas, i=1, 2, . . . , k) per location (x, y, z) and total.RF.exp(tissueₖ) is the total RF exposure for tissueₖ within the operating time-averaging window T Here, RF. exp. (Antᵢ, x, y, z, t) may be determined based on RF exposure contribution information, which may indicate one or more RF exposure contributors for the location (x, y, z). Note that the tissue mask tissue.maskₖ (x, y, z, t) may change with time (e.g., due to movement of tissueₖ).

In certain aspects, in cases where the tissue mask (e.g., tissue.mask(x, y, z, t) or tissue.maskₖ(x, y, z, t)) is indicated for a region surrounding a particular location (x, y, z) on the wireless device, the total RF exposure determined according to Equations 10 or 11 may be representative of a highest RF exposure for the region, e.g., for a conservative RF exposure evaluation.

In certain aspects, the time-averaged RF exposure evaluation may be performed according to Equation 10 when tissues cannot be differentiated from the sensor information (e.g., all tissues are treated the same, tissue.mask=1 or 0). In other aspects, the time-averaged RF exposure evaluation may be performed according to Equation 11 when the type of tissue (e.g., tissue.maskₖ for m tissue IDs, k=1, 2, 3 . . . m) can be identified. Here, since tissue can move to different locations (x, y, z) over time, all exposures of tissueₖ movement may be summed up over all locations on the device during the time-averaged RF exposure evaluation. Therefore, implementation of Equation 11 may include tracking RF exposure for all m tissue IDs separately.

Note, in certain aspects, there may be scenarios where the wireless device can identify certain tissues and cannot identify other tissues. By way of example, the wireless device may be equipped with sensors that can detect certain areas of the human body, such as left side of head and right side of head. However, such sensors may not be able to detect other areas of the human body, such as left/right arm, left/right palm, etc. and/or the wireless device may not include other sensors that are capable of detecting these other areas of the human body. In some such aspects, the time-averaged RF exposure evaluation according to Equation 11 may involve using a default tissue ID for the tissues that cannot be identified. In some other such aspects, the time-averaged RF exposure evaluation according to Equation 11 may involve using a tissue ID for one of the detected tissues for the tissues that cannot be identified. In yet some other such aspects, the time-averaged RF exposure evaluation according to Equation 11 may involve including the RF exposure for the tissues that cannot be identified as part of the respective RF exposure tracking for each identified tissue ID.

In certain aspects, the time-averaged RF exposure evaluation in Equations 10 and 11 may enable desirable transmit power for specific radios, antennas, and/or antenna groups. For example, performing time-averaged RF exposure evaluation according to Equations 7-9 may limit the time-averaged transmit power to Pₗᵢₘᵢₜ, since Equations 7-9 may assume that any detected tissue is present for an entirety of the time-averaging window. On the other hand, the time-averaged RF exposure evaluation in Equations 10-11 may allow for the time-averaged transmit power to be greater than Pₗᵢₘᵢₜ, depending on the RF exposure at and/or surrounding a given tissue's location over time.

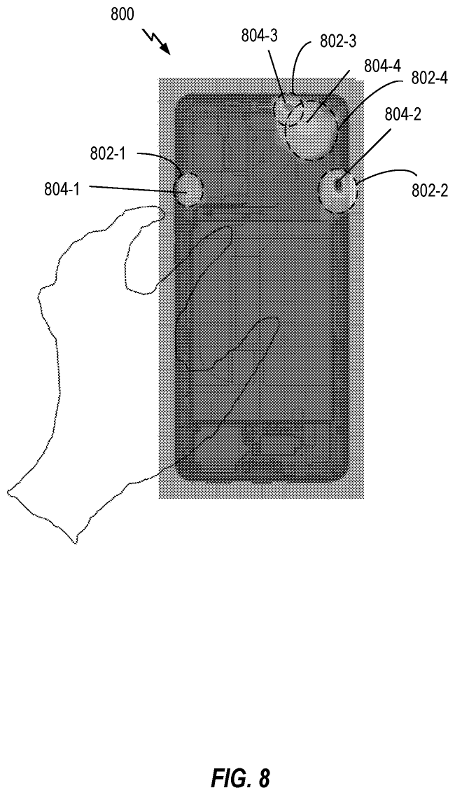

By way of example, consider FIG. 8 which depicts an example of RF exposure contours 802-1 to 802-4 for four exposure hotspots 804-1 to 804-4, respectively, of wireless device 800, according to certain aspects of the present disclosure. Here, at each instant in time, if tissue presence is outside the RF exposure contours 802-1 to 802-4 and/or outside X dB (e.g., X=20 or some other threshold) from each hotspot 804, then the time-averaged RF exposure at that instant in time may be X dB below the peak value. Therefore, if the tissue is not present within the RF exposure contours 802-1 to 802-4 and/or not within X dB from each hotspot 804 over the duration of a past time window, then the transmit power could have been X dB above Pₗᵢₘᵢₜ for the duration of the past time window. Thus, for at least a duration of a future time window, the transmit power may be boosted by X dB above Pₗᵢₘᵢₜ.

In another illustrative example, assume non-critical regions on the wireless device include locations on the wireless device that have exposure between 0% and 10% of peak exposure. In this example, if tissue presence is triggered for these non-critical regions over a duration of a past time window (or portion thereof) (e.g., tissue is present in locations on the wireless device that have exposure less than 10% of peak exposure), then the transmit power may be 1/(10%) of Pₗᵢₘᵢₜ for at least a duration of a future time window. That is, the wireless device may transmit at 10*Pₗᵢₘᵢₜ as transmitting at 10*Pₗᵢₘᵢₜ*exposure at locations less than 10% of peak exposure may still be in compliance with the time-averaged RF exposure limit.

In certain aspects, the wireless device may use a trained machine learning model to determine the transmit power for a future time window based on the tracked RF exposure and tracked tissue presence. The machine learning model may be trained to predict transmit power levels that comply with the RF exposure limit while optimizing (or at least improving) wireless communication performance (e.g., maximizing (or at least increasing) data rates, minimizing (or at least reducing) latency, and/or increasing transmission range). In some cases, the machine learning model may receive as input the tracked RF exposure, tracked tissue presence, and/or other parameters (e.g., RF exposure contribution information, antenna configurations, operating conditions, frequency bands), and output a transmit power level or a transmit power adjustment (e.g., a power backoff value). In some cases, the machine learning model may be trained using training data comprising historical RF exposure data, sensor information indicating tissue presence, and corresponding transmit power levels that were determined to comply with RF exposure limits.

Additionally, in certain aspects, if sensor(s) provide tissue presence and/or registration information, then antenna elements far away from sensors may be excited as these antenna elements could provide higher transmit power. In some cases, antennas that are least used (e.g., antennas that have low time-averaged RF exposure) can allow for high transmit power (as there is more RF exposure margin available). In certain aspects, if the wireless device includes a distributed antenna elements system with antenna elements spaced apart on the device (unlike a mmW module having all antenna elements nearby), the wireless device can excite beams from a codebook that uses antenna elements far away from the detected tissue. That is, the wireless device may perform beam selection to excite multiple “tissue-free” antenna elements that form the beam.

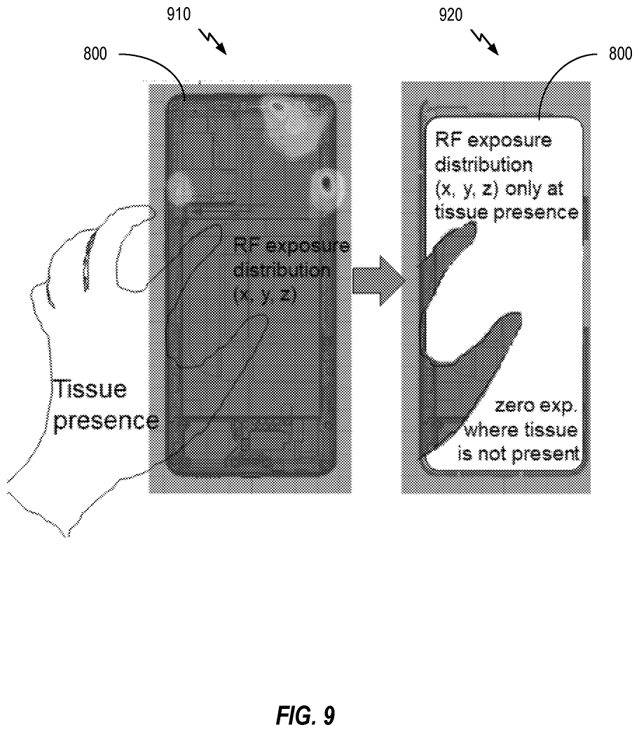

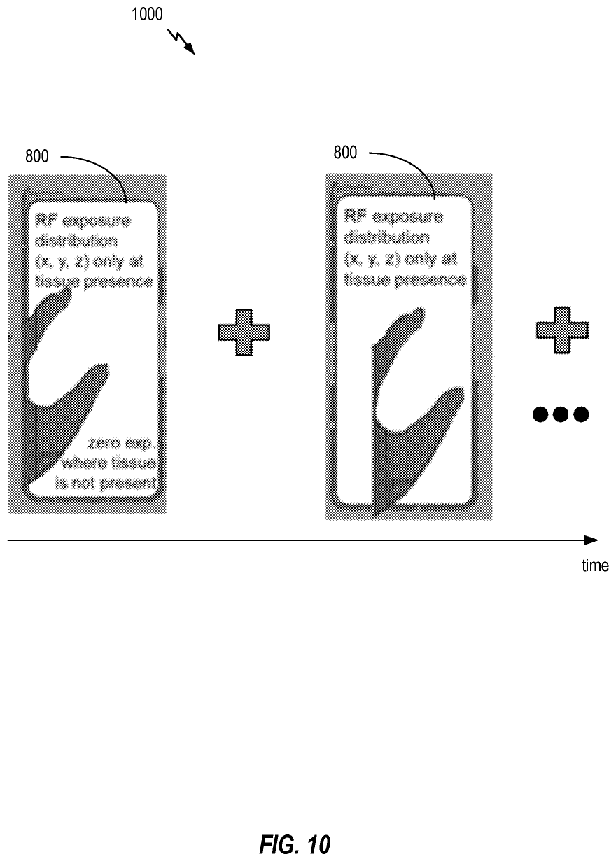

FIG. 9 illustrates an example scenario 910 in which time-averaged RF exposure is evaluated without sensor information indicating tissue presence for the wireless device 800 and a scenario 920 in which time-averaged RF exposure is evaluated based on sensor information indicating tissue presence for the wireless device 800. As shown in scenario 920 of FIG. 9, compared to scenario 910, tissue-detection sensor information (e.g., tissue mask) may be overlaid with the RF exposure contribution information for the wireless device 800. With the tissue-detection sensor information, the time-averaged RF exposure evaluation may be performed at and/or surrounding locations where tissue is present. Note, since tissue movements may change with time, the time-averaged RF exposure evaluation may be performed with the tissue mask included. FIG. 10, for example, illustrates an example scenario 1000 in which time-averaged RF exposure is evaluated with tissue-detection sensor information with tissue movement over time, according to certain aspects of the present disclosure.

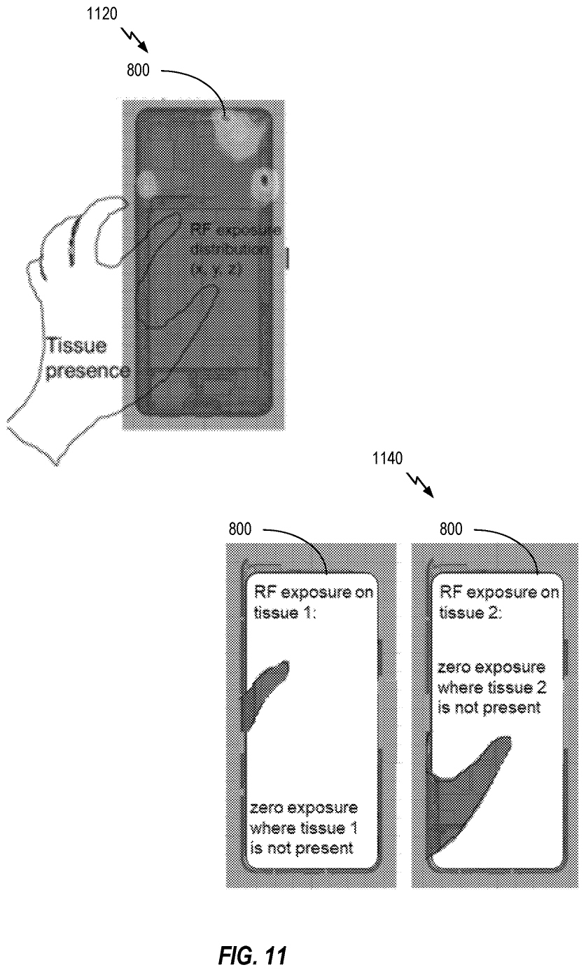

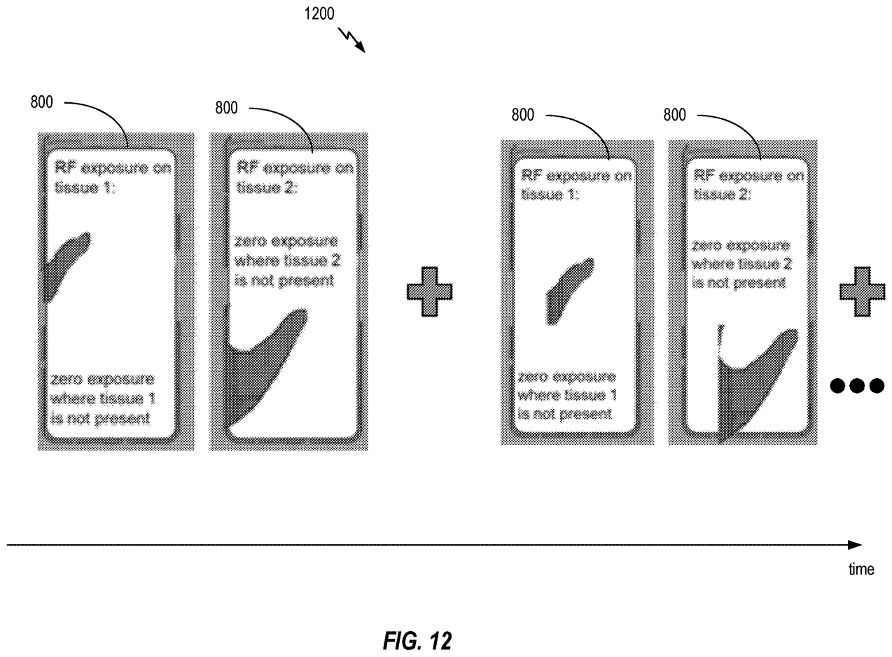

FIG. 11 illustrates an example scenario 1120 in which time-averaged RF exposure is evaluated without sensor information indicating tissue presence for the wireless device 800 and a scenario 1140 in which time-averaged RF exposure is evaluated based on sensor information indicating presence of particular types of tissue (e.g., tissue registration) for the wireless device 800. As shown in scenario 1140 of FIG. 11, compared to scenario 1120, tissueₖ-detection sensor information (e.g., tissue mask per tissue ID) may be overlaid with the RF exposure contribution information for the wireless device 800. With the tissueₖ-detection sensor information, the time-averaged RF exposure evaluation may be performed per tissue ID (e.g., index finger vs. thumb) based on RF exposure at and/or surrounding each tissueₖ's location. Note, since tissueₖ movements may change with time, the RF exposure may be summed up over time based on tissueₖ movement. FIG. 12, for example, illustrates an example scenario 1200 in which time-averaged RF exposure is evaluated per tissueₖ with movement of tissueₖ over time, according to certain aspects of the present disclosure.

### Example Operations for Wireless Communications

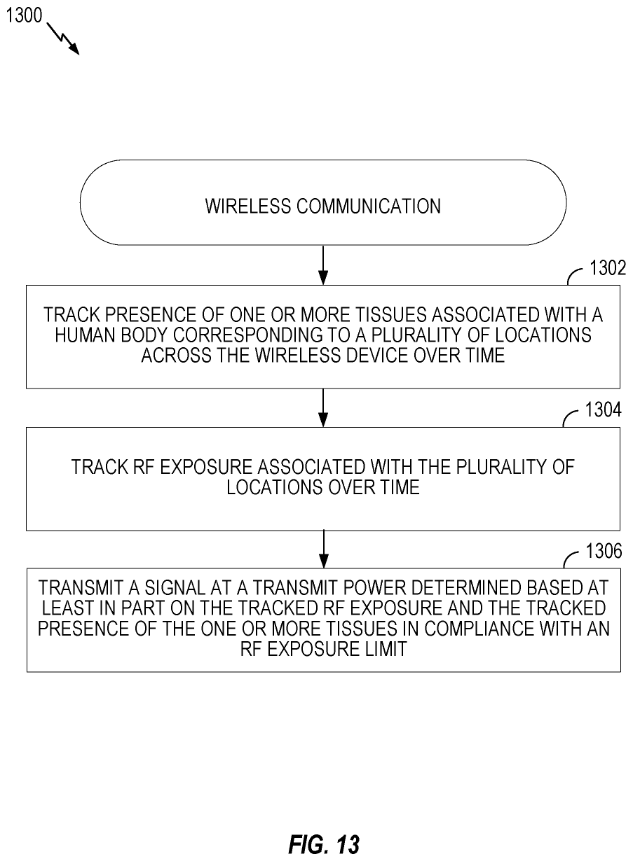

FIG. 13 is a flow diagram illustrating example operations 1300 for wireless communication. The operations 1300 may be performed, for example, by a wireless device (e.g., the wireless device 102 in the wireless communication system 100) and/or a processing system. The operations 1300 may be implemented as software components that are executed and run on one or more processors (e.g., the processor 210 and/or the modem 212 of FIG. 2), for example by the RF exposure manager 106.

The operations 1300 may involve, at block 1302, tracking presence of one or more tissues associated with a human body corresponding to a plurality of locations across the wireless device over time. The plurality of locations may include multiple locations on each of one or more surfaces of the wireless device. For example, tissue presence can be tracked for a first set of locations across a first surface of the wireless device (e.g., front surface), a second set of locations across a second surface of the wireless device (e.g., back surface), and so on. For each location within a set of locations, tissue presence may be tracked at and/or surrounding the location over time.

The operations 1300 may also involve, at block 1304, tracking RF exposure associated with the plurality of locations over time.

The operations 1300 may further involve, at block 1306, transmitting a signal at a transmit power determined based at least in part on the tracked RF exposure and the tracked presence of the one or more tissues in compliance with an RF exposure limit.

In certain aspects, tracking the presence of the one or more tissues associated with the human body may include obtaining sensor information indicating, for each of the plurality of locations, whether at least one of the one or more tissues is detected for the location. For example, the sensor information may indicate, for each of the plurality of locations, whether at least one of the one or more tissues is detected at and/or surrounding the location.

In certain aspects, the sensor information may indicate, for each of the plurality of locations where the at least one of the one or more tissues is detected, a type of the at least one of the one or more tissues that is detected for the location. For example, the sensor information may indicate, for each of the plurality of locations, a type of tissue that is detected at and/or surrounding the location.

In certain aspects, the sensor information may be obtained from one or more sensors associated with the wireless device. In some aspects, the one or more sensors may be arranged in a grid. In some aspects, each sensor may provide tissue presence in one or more regions covering multiple locations on the wireless device. In some aspects, the one or more sensors may include one or more touch sensors. In some aspects, the one or more sensors may include at least two different types of sensors. In such aspects, the sensor information may be generated from combining first sensor information from a first type of sensor and second sensor information from a second type of sensor. In some aspects, a total number of the one or more sensors may be less than a total number of the plurality of locations. In some aspects, a total number of the one or more sensors may be equal to a total number of the plurality of locations.

In certain aspects, each location may be representative of (i) one or more points of an RF exposure region associated with at least one antenna of the wireless device or (ii) one or more values of RF exposure contributions associated with the at least one antenna.

In certain aspects, tracking RF exposure associated with the plurality of locations may include determining a time-averaged RF exposure associated with the plurality of locations within a moving time window associated with the RF exposure limit, based at least in part on sensor information indicating, for each of the plurality of locations, whether at least one of the one or more tissues, is detected for the location.

In some aspects, determining the time-averaged RF exposure may include: for each location of the plurality of locations at which tissue is detected, determining a respective amount of RF exposure (total RF exposure in case of multiple active antennas/radios) for the location; summing the respective amounts of RF exposure to determine a total RF exposure within the moving time window; and averaging the total RF exposure over the moving time window.

In some aspects, the sensor information may indicate, for each of the plurality of locations, a type of tissue that is detected for the location. In such aspects, determining the time-averaged RF exposure may include: for each location of the plurality of locations, determining a respective amount of RF exposure for the type of tissue detected for the location; summing the respective amounts of RF exposure to determine a total RF exposure for the type of tissue within the moving time window; and averaging the total RF exposure over the moving time window.

In certain aspects, the signal may be transmitted from at least one antenna of the wireless device. In such aspects, the operations 1300 may further involve determining the at least one antenna based at least in part on the tracked presence of the one or more tissues.

In certain aspects, the RF exposure limit may be a time-averaged RF exposure limit.

### Example Communications Device

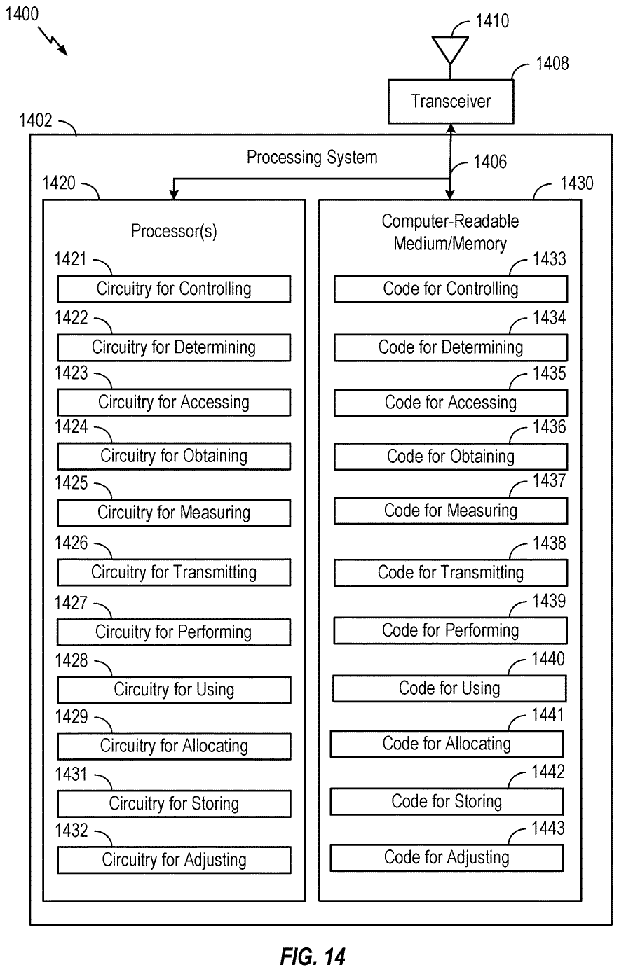

FIG. 14 depicts aspects of an example communications device 1400. In some aspects, communications device 1400 is a wireless communication device, such as the wireless device 102 described above with respect to FIGS. 1 and 2.

The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes one or more processors 1420. In various aspects, the one or more processors 1420 may be representative of any of the processor 210 and/or the modem 212, as described with respect to FIG. 2. The one or more processors 1420 are coupled to a computer-readable medium/memory 1430 via a bus 1406. In certain aspects, the computer-readable medium/memory 1430 is configured to store instructions (e.g., computer-executable code) that when executed by the one or more processors 1420, cause the one or more processors 1420 to perform the operations 1300 described with respect to FIG. 13 or any aspect related to the operations described herein. Note that reference to a processor performing a function of communications device 1400 may include one or more processors performing that function of communications device 1400.

In the depicted example, computer-readable medium/memory 1430 stores code (e.g., executable instructions) for controlling 1433 (including code for operating, code for refraining, and code for ceasing), code for determining 1434 (including code for detecting), code for accessing 1435, code for obtaining 1436, code for measuring 1437, code for transmitting 1438 (including code for sending), code for performing 1439, code for using 1440, code for allocating 1441, code for storing 1442, and code for adjusting 1443 (collectively referred to herein as code 1433-1443). Processing of the code 1433-1443 may cause the communications device 1400 to perform the operations 1300 described with respect to FIG. 13 or any aspect related to operations described herein.

The one or more processors 1420 include circuitry configured to implement (e.g., execute) the code stored in the computer-readable medium/memory 1430, including circuitry for controlling 1421 (including circuitry for operating, circuitry for ceasing, and circuitry for refraining), circuitry for determining 1422 (including circuitry for detecting), circuitry for accessing 1423, circuitry for obtaining 1424, circuitry for measuring 1425, circuitry for transmitting 1426 (including circuitry for sending), circuitry for performing 1427, circuitry for using 1428, circuitry for allocating 1429, circuitry for storing 1431, and circuitry for adjusting 1432 (collectively referred to herein as circuitry 1421-1432). Processing with circuitry 1421-1432 may cause the communications device 1400 to perform the operations 1300 described with respect to FIG. 13 or any aspect related to operations described herein.

Various components of the communications device 1400 may provide means for performing the operations 1300 described with respect to FIG. 13 or any aspect related to operations described herein. For example, means for transmitting, sending or outputting for transmission may include the TX path 214 and/or antenna(s) 218 of the wireless device 102 illustrated in FIG. 2 and/or transceiver 1408 and antenna 1410 of the communications device 1400 in FIG. 14. Means for receiving or obtaining may include the RX path 216 and/or antenna(s) 218 of the wireless device 102 illustrated in FIG. 2, and/or transceiver 1408 and antenna 1410 of the communications device 1400 in FIG. 14. Means for controlling, means for measuring, means for accessing, means for allocating, means for storing, means for adjusting, means for using, means for performing, means for operating, means for ceasing, means for refraining, means for determining, means for detecting, means for monitoring, means for comparing, means for obtaining, and/or means for providing may include a processor, such as the processor 210 and/or modem 212 depicted in FIG. 2 and/or the processor(s) 1420 in FIG. 14.

### Example Aspects

Implementation examples are described in the following numbered clauses:
Clause 1: A method of wireless communication by a wireless device, comprising: tracking presence of one or more tissues associated with a human body corresponding to a plurality of locations across the wireless device over time; tracking RF exposure associated with the plurality of locations over time; and transmitting a signal at a transmit power determined based at least in part on the tracked RF exposure and the tracked presence of the one or more tissues in compliance with an RF exposure limit.
Clause 2: The method of Clause 1, wherein tracking the presence of the one or more tissues associated with the human body comprises obtaining sensor information indicating, for each of the plurality of locations, whether at least one of the one or more tissues is detected for the location.
Clause 3: The method of Clause 2, wherein the sensor information further indicates, for each of the plurality of locations where the at least one of the one or more tissues is detected, a type of the at least one of the one or more tissues that is detected for the location.
Clause 4: The method according to any of Clauses 2-3, wherein the sensor information is obtained from one or more sensors associated with the wireless device.
Clause 5: The method of Clause 4, wherein the one or more sensors are arranged in a grid.
Clause 6: The method according to any of Clauses 4-5, wherein the one or more sensors comprise one or more touch sensors.
Clause 7: The method according to any of Clauses 4-6, wherein: the one or more sensors comprise at least two different types of sensors; and the sensor information is generated from combining first sensor information from a first type of sensor and second sensor information from a second type of sensor.
Clause 8: The method according to any of Clauses 4-6, wherein each of the one or more sensors is a same type of sensor.
Clause 9: The method according to any of Clauses 4-8, wherein a total number of the one or more sensors is less than a total number of the plurality of locations.
Clause 10: The method according to any of Clauses 4-8, wherein a total number of the one or more sensors is equal to a total number of the plurality of locations.
Clause 11: The method according to any of Clauses 1-10, wherein each location is representative of (i) one or more points of an RF exposure region associated with at least one antenna of the wireless device or (ii) one or more values of RF exposure contributions associated with the at least one antenna.
Clause 12: The method according to any of Clauses 1-11, wherein tracking RF exposure associated with the plurality of locations comprises determining a time-averaged RF exposure associated with the plurality of locations within a moving time window associated with the RF exposure limit, based at least in part on sensor information indicating, for each of the plurality of locations, whether at least one of the one or more tissues is detected for the location.
Clause 13: The method of Clause 12, wherein determining the time-averaged RF exposure comprises: for each location of the plurality of locations at which tissue is detected, determining a respective amount of RF exposure for the location; summing the respective amounts of RF exposure to determine a total RF exposure within the moving time window; and averaging the total RF exposure over the moving time window.
Clause 14: The method of Clause 12, wherein: the sensor information further indicates, for each of the plurality of locations, a type of tissue that is detected for the location; and determining the time-averaged RF exposure comprises: for each location of the plurality of the locations, determining a respective amount of RF exposure for the type of tissue detected for the location; summing the respective amounts of RF exposure to determine a total RF exposure for the type of tissue within the moving time window; and averaging the total RF exposure over the moving time window.
Clause 15: The method according to any of Clauses 1-14, wherein the signal is transmitted from at least one antenna of the wireless device, the method further comprising determining the at least one antenna based at least in part on the tracked presence of the one or more tissues.
Clause 16: The method according to any of Clauses 1-15, wherein the RF exposure limit is a time-averaged RF exposure limit.
Clause 17: An apparatus comprising: one or more memories collectively storing executable instructions; and one or more processors coupled to the one or more memories, the one or more processors being collectively configured to execute the executable instructions and cause the apparatus to perform a method in accordance with any of Clauses 1-16.
Clause 18: An apparatus for wireless communications, comprising means for performing a method in accordance with any of Clauses 1-16.
Clause 19: A non-transitory computer-readable medium comprising computer-executable instructions that, when executed by one or more processors of a processing system, cause the processing system to perform a method in accordance with any of Clauses 1-16.
Clause 20: A computer program product embodied on a computer-readable storage medium comprising code for performing a method in accordance with any of Clauses 1-16.

### Additional Considerations

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements (e.g., one or more dies and/or other components) packaged together.

The various illustrative logical blocks, modules and circuits described in connection with the present disclosure may be implemented or performed with a general purpose processor, a digital signal processor (DSP), a neural network processor, a system on chip (SoC), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the operations described herein and illustrated in FIG. 13).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
tracking presence of one or more tissues associated with a human body corresponding to a plurality of locations across the wireless device over time;
tracking RF exposure associated with the plurality of locations over time; and
transmitting a signal at a transmit power determined based at least in part on the tracked RF exposure and the tracked presence of the one or more tissues in compliance with an RF exposure limit.

2. The method of claim 1, wherein tracking the presence of the one or more tissues associated with the human body comprises obtaining sensor information indicating, for each of the plurality of locations, whether at least one of the one or more tissues is detected for the location.

3. The method of claim 2, wherein the sensor information further indicates, for each of the plurality of locations where the at least one of the one or more tissues is detected, a type of the at least one of the one or more tissues that is detected for the location.

4. The method of claim 2, wherein the sensor information is obtained from one or more sensors associated with the wireless device.

5. The method of claim 4, wherein the one or more sensors are arranged in a grid.

6. The method of claim 4, wherein the one or more sensors comprise one or more touch sensors.

7. The method of claim 4, wherein:
the one or more sensors comprise at least two different types of sensors; and
the sensor information is generated from combining first sensor information from a first type of sensor and second sensor information from a second type of sensor.

8. The method of claim 4, wherein each of the one or more sensors is a same type of sensor.

9. The method of claim 4, wherein a total number of the one or more sensors is less than a total number of the plurality of locations.

10. The method of claim 4, wherein a total number of the one or more sensors is equal to a total number of the plurality of locations.

11. The method of claim 1, wherein each location is representative of (i) one or more points of an RF exposure region associated with at least one antenna of the wireless device or (ii) one or more values of RF exposure contributions associated with the at least one antenna.

12. The method of claim 1, wherein tracking RF exposure associated with the plurality of locations comprises determining a time-averaged RF exposure associated with the plurality of locations within a moving time window associated with the RF exposure limit, based at least in part on sensor information indicating, for each of the plurality of locations, whether at least one of the one or more tissues is detected for the location.

13. The method of claim 12, wherein determining the time-averaged RF exposure comprises:
for each location of the plurality of locations at which tissue is detected, determining a respective amount of RF exposure for the location;
summing the respective amounts of RF exposure to determine a total RF exposure within the moving time window; and
averaging the total RF exposure over the moving time window.

14. The method of claim 12, wherein:
the sensor information further indicates, for each of the plurality of locations, a type of tissue that is detected for the location; and
determining the time-averaged RF exposure comprises:
for each location of the plurality of the locations, determining a respective amount of RF exposure for the type of tissue detected for the location;
summing the respective amounts of RF exposure to determine a total RF exposure for the type of tissue within the moving time window; and
averaging the total RF exposure over the moving time window.

15. The method of claim 1, wherein the signal is transmitted from at least one antenna of the wireless device, the method further comprising determining the at least one antenna based at least in part on the tracked presence of the one or more tissues.

16. The method of claim 1, wherein the RF exposure limit is a time-averaged RF exposure limit.

17. An apparatus for wireless communication, comprising:
one or more memories collectively storing executable instructions; and
one or more processors coupled to the one or more memories, the one or more processors being collectively configured to execute the executable instructions to cause the apparatus to:
track presence of one or more tissues associated with a human body corresponding to a plurality of locations across the apparatus over time;
track RF exposure associated with the plurality of locations over time; and
transmit a signal at a transmit power determined based at least in part on the tracked RF exposure and the tracked presence of the one or more tissues in compliance with an RF exposure limit.

18. The apparatus of claim 17, wherein to track the presence of the one or more tissues, the one or more processors are collectively configured to execute the instructions to cause the apparatus to obtain sensor information indicating, for each of the plurality of locations, whether at least one of the one or more tissues is detected for the location.

19. The apparatus of claim 18, wherein the sensor information further indicates, for each of the plurality of locations where the at least one of the one or more tissues is detected, a type of the at least one of the one or more tissues that is detected for the location.

20. An apparatus for wireless communication, comprising:
means for tracking presence of one or more tissues associated with a human body corresponding to a plurality of locations across the apparatus over time;
means for tracking RF exposure associated with the plurality of locations over time; and
means for transmitting a signal at a transmit power determined based at least in part on the tracked RF exposure and the tracked presence of the one or more tissues in compliance with an RF exposure limit.
